(19) United States
(12) Patent Application Publication
(10) Pub. No.: US 2025/0308347 A1
(43) Pub. Date: Oct. 2, 2025

(54) CHECKOUT SYSTEM AND CONTROL METHOD FOR CHECKOUT SYSTEM

(71) Applicant: Toshiba Tec Kabushiki Kaisha, Tokyo (JP)

(72) Inventors: Hiroki ENDO, Ota Tokyo (JP); Ichiro FUKUZAWA, Ota Tokyo (JP)

(21) Appl. No.: 18/950,907

(22) Filed: Nov. 18, 2024

(30) Foreign Application Priority Data
Mar. 26, 2024 (JP) 2024-049751

(51) Int. Cl. G07G 1/00; G06Q 20/40

(52) U.S. Cl. CPC G07G 1/0045; G06Q 20/401

(57) ABSTRACT

According to an embodiment, a checkout system stores, in a storage device, list data indicating a list of transaction products that are subjects of a transaction in a store for each paid transaction. The checkout system narrows down transactions including one or more products identified by one or more identifiers acquired by a scanner as transaction products by referring to the list data stored in the storage device. Further, the checkout system controls a notification device to notify a customer of that he/she is allowed to pass through in accordance with narrowing down of the transactions to one transaction.

### CROSS-REFERENCE TO RELATED APPLICATIONS

This application is based upon and claims the benefit of priority from the prior Japanese Patent Application No. 2024-49751, filed on Mar. 26, 2024, the entire contents of which are incorporated herein by reference.

### FIELD

An embodiment to be described here generally relates to a checkout system and a control method for a checkout system.

### BACKGROUND

In stores in which a payment is made for transactions such as buying and selling of products, it is desired to properly guide customers who have completed the payment to leave the store.

### BRIEF DESCRIPTION OF THE DRAWINGS

FIG. 1 is a configuration diagram of an entire product sales system according to an embodiment.

FIG. 2 is a schematic diagram showing a layout example of a checkout corner of a store where the product sales system is introduced.

FIG. 3 is a block diagram showing a main circuit configuration of a transaction processing apparatus in FIG. 1.

FIG. 4 is a block diagram showing a main circuit configuration of a POS terminal in FIG. 1.

FIG. 5 is a block diagram showing a main circuit configuration a POS terminal in FIG. 1.

FIG. 6 is a block diagram showing a main circuit configuration of an accounting gate in FIG. 1.

FIG. 7 is a perspective view showing appearance of the accounting gate in FIG. 1.

FIG. 8 is a block diagram showing a main circuit configuration of an information processing terminal in FIG. 1.

FIG. 9 is a block diagram showing a main circuit configuration of a monitoring terminal in FIG. 1.

FIG. 10 is a block diagram showing a main circuit configuration of a POS server in FIG. 1.

FIG. 11 is a sequence diagram relating to processing of a transaction using the information processing terminal in FIG. 1.

FIG. 12 is a flowchart of gate control processing.

FIG. 13 is a flowchart of the gate control processing.

FIG. 14 is a flowchart of the gate control processing.

FIG. 15 is a screen showing an example of a stand-by screen displayed on a touch panel in FIG. 6.

FIG. 16 is a screen showing an example of a stand-by screen displayed on a display device in FIG. 6.

FIG. 17 is a flowchart of pass-through allowance processing.

FIG. 18 is a diagram showing an example of a first guidance screen.

FIG. 19 is a diagram showing an example of a second guidance screen.

FIG. 20 is a sequence diagram relating to processing of a transaction using the POS terminal in FIG. 1.

FIG. 21 is a sequence diagram relating to processing of a transaction using the POS terminal in FIG. 1.

FIG. 22 is a flowchart of transaction search processing.

FIG. 23 is a diagram showing an example of an additional request screen.

FIG. 24 is a flowchart of sales clerk call processing by a processor in FIG. 6 and instruction processing by a processor in FIG. 9.

FIG. 25 is a diagram showing an example of a calling screen.

FIG. 26 is a diagram showing an example of a warning screen.

FIG. 27 is a flowchart of leaving checking processing.

FIG. 28 is a flowchart of false pass processing by the processor in FIG. 6 and alarm processing by the processor in FIG. 9.

FIG. 29 is a diagram showing an example of a first warning screen.

FIG. 30 is a diagram showing a modification of the gate control processing.

FIG. 31 is a diagram showing an example of a stand-by screen adapted to a modification.

### DETAILED DESCRIPTION

According to an embodiment, a checkout system includes: a storage device; a scanner; a notification device; a first processor; and a second processor. The storage device stores list data indicating a list of transaction products that are subjects of a transaction in a store for each paid transaction. The scanner acquires an identifier of a product in accordance with an operation of a customer. The notification device notifies the customer of that he/she is allowed to pass through. The first processor is configured to narrow down transactions including one or more products identified by one or more identifiers acquired by the scanner as transaction products by referring to the list data stored in the storage device. Further, the second processor is configured to control the notification device to notify the customer of that he/she is allowed to pass through in accordance with narrowing down of the transactions to one transaction by the first processor.

A product sales system that performs processing relating to product sales to customers in a store will be described below with reference to the drawings. Note that in the drawings, the same reference symbols denote the same or similar portions. The product sales system is also an example of a transaction processing system that processes product sales as a target transaction. The transaction to be processed may be a transaction of a type different from product sales, such as provision of arbitrary service in a store. However, a customer is allowed to leave the store after he/she completes a payment relating to the transaction to be processed.

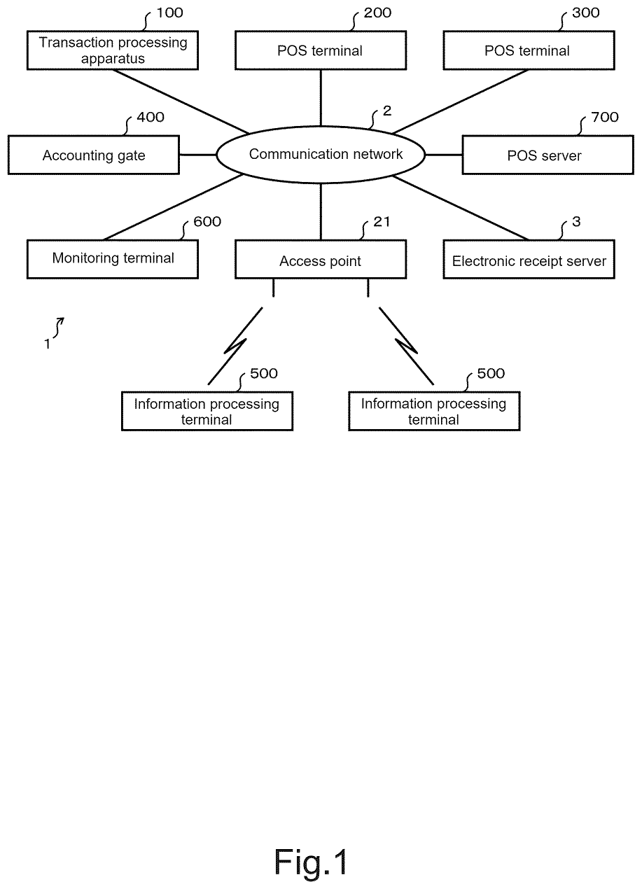

FIG. 1 is a configuration diagram of an entire product sales system 1 according to this embodiment. The product sales system 1 includes a transaction processing apparatus 100, point-of-sale (POS) terminals 200 and 300, an accounting gate 400, an information processing terminal 500, a monitoring terminal 600, and a POS server 700. The product sales system 1 is configured such that the transaction processing apparatus 100, the POS terminal 200, the accounting gate 400, the information processing terminal 500, the monitoring terminal 600, and the POS server 700 are capable of communicating with each other via a communication network 2. Note that the POS terminal 200 and the accounting gate 400 are also capable of communicating with an electronic receipt server 3 via the communication network 2. The electronic receipt server 3 provides an electronic receipt service that allows an electronic receipt screen showing the content of a transaction processed by the product sales system 1 to be viewed using an arbitrary information terminal.

Although one POS terminal 200, one POS terminal 300, one information processing terminal 500, one monitoring terminal 600, and one POS server 700 and three accounting gates 400 are shown in FIG. 1, the numbers thereof are individually arbitrary. One or two of the POS terminal 200, the POS terminal 300, and the information processing terminal 500 may be provided, and one or two of the others do not necessarily need to be provided. If provided, the POS terminal 200, the POS terminal 300, and the information processing terminal 500 respectively include a plurality of POS terminals 200, a plurality of POS terminals 300, and a plurality of information processing terminals 500 in the product sales system 1 in many cases.

As the communication network 2, the Internet, a virtual private network (VPN), a local area network (LAN), a public communication network, a mobile communication network, and the like can be used alone or in combination as appropriate. As the communication network 2, a LAN, the Internet, and a mobile communication network are used in combination as an example. For the communication between the transaction processing apparatus 100, the POS terminal 200, the accounting gate 400, the information processing terminal 500, the monitoring terminal 600, and the POS server 700, for example, a LAN is used. For the communication between the transaction processing apparatus 100 and the information processing terminal 500, for example, a LAN is used. However, the information processing terminal 500 is connected to the communication network 2 by wireless access via an access point 21 included in the communication network 2. For the communication between the POS terminal 200 or the accounting gate 400 and the electronic receipt server 3, for example, a LAN and the Internet are used.

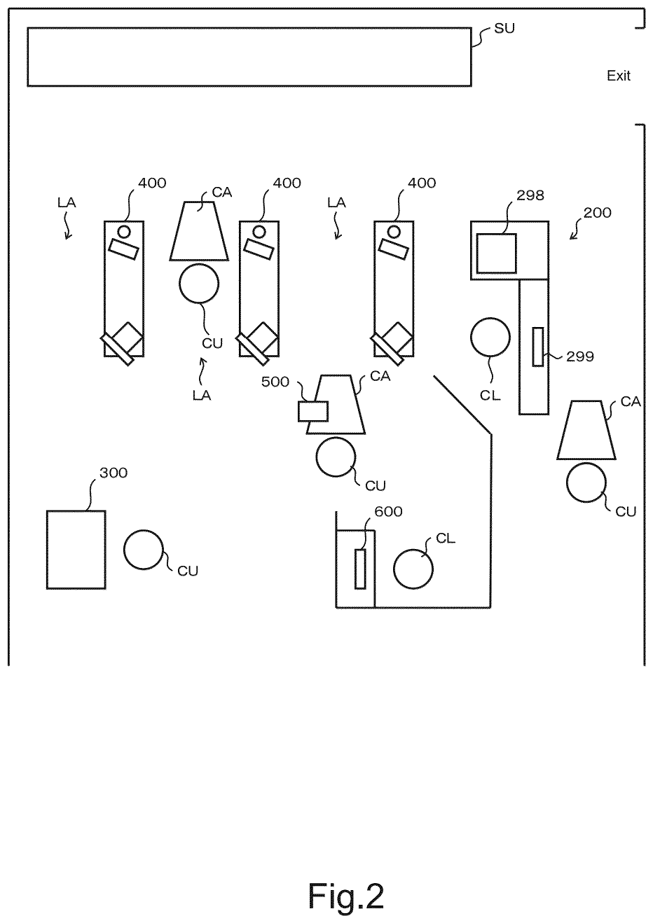

FIG. 2 is a schematic diagram showing a layout example of a checkout corner of a store where the product sales system 1 is introduced. The information processing terminal 500 is temporarily operated by a customer CU who is shopping in the store. The information processing terminal 500 is attached to, for example, a shopping cart (hereinafter, referred to simply as a cart) CA. The information processing terminal 500 may be carried by the customer CU. As the information processing terminal 500, for example, an existing portable information processing apparatus such as a tablet computer, a smartphone, and a smart watch can be used. The information processing terminal 500 may be one that is provided in the store and temporarily used by the customer CU, or may be one owned by the customer CU. The customer CU goes around the sales floor while pushing the cart CA and places a product to be purchased directly on the cart CA or in a basket placed on the cart CA. At this time, the customer CU operates the information processing terminal 500 to perform an operation for registering the product placed on the cart CA as a transaction product. The transaction processing apparatus 100 registers the transaction product in accordance with the operation in the information processing terminal 500. Note that the information processing terminal 500 may be operated by a sales clerk CL instead of the customer CU. When the customer CU has finished selecting all products to be purchased, he/she goes to the checkout corner and uses the accounting gate 400 to make a payment. After that, the customer CU passes through a checkout lane LA that the accounting gate 400 used for the payment faces and then leaves the store. Note that in the case where a plurality of accounting gates 400 is installed as shown in FIG. 2, the plurality of accounting gates 400 in installed to face the corresponding one of a plurality of checkout lanes LA. The accounting gate 400 also has a leaving gate function for controlling the passage of the customer CU in the facing checkout lane LA and is an example of a gate device. This leaving gate function will be described below. The customer CU passes through the checkout lane LA and then bags the products at a bagging table as necessary. Thus, the product sales system 1 is also a checkout system for checking out in a store.

Further, the customer CU may also have the sales clerk CL who is responsible for operating the POS terminal 200 register the products to be purchased as transaction products, without using the information processing terminal 500. The sales clerk CL operates the POS terminal 200 to register the products brought in by the customer CU as transaction products and process his/her payment. That is, the POS terminal 200 is of a so-called face-to-face type. The operation of the POS terminal 200 may be the same as that of the existing POS terminal of the same type. Note that in FIG. 2, the POS terminal 200 is an example of a separate type that is separated into a body device 298 and a scanner device 299. The POS terminal 200 may be of a different configuration such as an integrated type. Further, the POS terminal 200 may be of a semi-self-service type including a registration terminal to be operated by the sales clerk CL and an accounting terminal to be operated by the customer CU. The customer CU who has finished the payment at the POS terminal 200 leaves the store without passing through the checkout lane LA.

Further, the customer CU may also register the products to be purchased as transaction products and pay for the products by operating the POS terminal 300 by himself/herself without using the information processing terminal 500. That is, the POS terminal 300 is a so-called full-self-service type. The operation of the POS terminal 300 may be the same as that of the existing POS terminal of the same type. The customer CU who has finished the payment at the POS terminal 300 passes through the checkout lane LA and leaves the store. The monitoring terminal 600 assists the sales clerk CL who monitors illegal passage through the checkout lane LA. The POS server 700 is an information processing apparatus that manages the transaction processed by the product sales system 1.

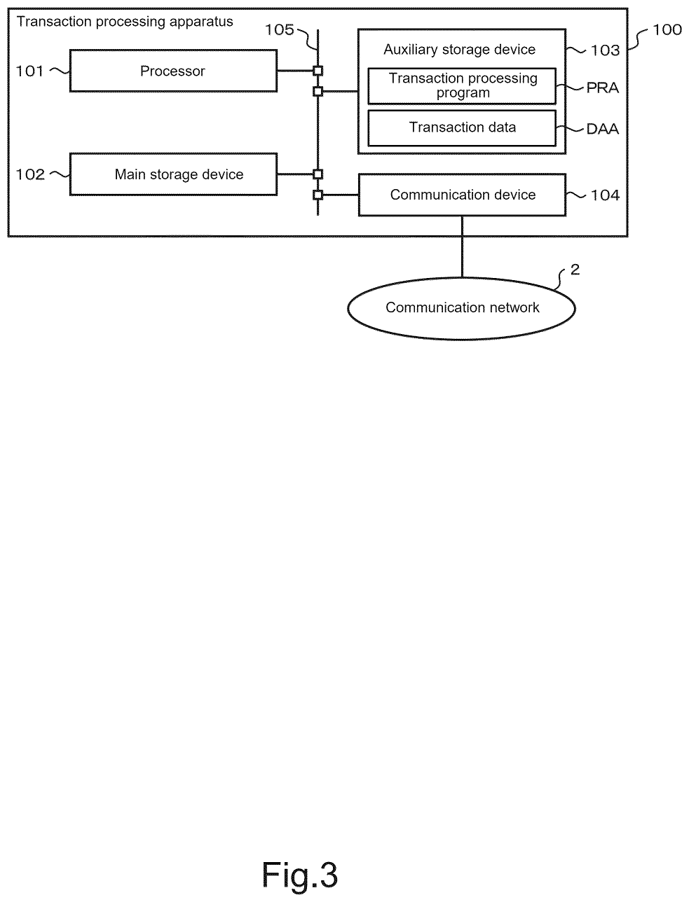

FIG. 3 is a block diagram showing a main circuit configuration of the transaction processing apparatus 100. The transaction processing apparatus 100 includes a processor 101, a main storage device 102, an auxiliary storage device 103, a communication device 104, a transmission path 105, and the like. The processor 101, the main storage device 102, the auxiliary storage device 103, and the communication device 104 are capable of communicating with each other via the transmission path 105.

By connecting the processor 101, the main storage device 102, and the auxiliary storage device 103 to each other via the transmission path 105, a computer that performs information processing for controlling the transaction processing apparatus 100 is configured. The processor 101 corresponds to the central part of the computer. The processor 101 executes information processing for controlling the respective units in order to realize various functions as the transaction processing apparatus 100 in accordance with an operating system and an information processing program such as an application program.

The main storage device 102 corresponds to the main storage part of the computer. The main storage device 102 includes a read-only memory area and a rewritable memory area. The main storage device 102 stores part of the information processing program in the read-only memory area. Further, the main storage device 102 stores data necessary for the processor 101 to execute processing for controlling the respective units in the read-only memory area or rewritable memory area in some cases. The main storage device 102 uses the rewritable memory area as a work area by the processor 101.

The auxiliary storage device 103 corresponds to the auxiliary storage part of the computer. As the auxiliary storage device 103, for example, an electric erasable programmable read-only memory (EEPROM), a hard disc drive (HDD), a solid state drive (SSD), or various other known storage devices can be used. The auxiliary storage device 103 stores data to be used for the processor 101 to perform various types of processing, and data generated by processing in the processor 101. The auxiliary storage device 103 stores the above information processing program in some cases. In this embodiment, the auxiliary storage device 103 stores a transaction processing program PRA that is an information processing program. The transaction processing program PRA is application program that describes a procedure of transaction processing described below. Part of the storage region of the auxiliary storage device 103 is used as a region for storing transaction data DAA. The transaction data DAA is data that indicates the content of one transaction.

The communication device 104 executes communication processing for performing data communication via the communication network 2. As the communication device 104, for example, an existing wired communication device for the Internet can be used. Note that as the communication device 104, a wireless communication device that is connected to the communication network 2 through wireless communication may be used instead of or in addition to the wired communication device. The transmission path 105 includes an address bus, a data bus, a control signal line, and the like, and transmits data and a control signal to be transmitted/received to/from the respective units connected to each other.

As basic hardware of the transaction processing apparatus 100, for example, a general-purpose server apparatus can be used. The transaction processing apparatus 100 is generally transferred while the transaction processing program PRA is stored in the auxiliary storage device 103. However, hardware without the transaction processing program PRA stored in the auxiliary storage device 103 or with a different version of application program of the same type stored in the auxiliary storage device 103 and the transaction processing program PRA may be individually transferred. The transaction processing apparatus 100 may then be configured by writing the transaction processing program PRA to the auxiliary storage device 103 in accordance with an operation of an arbitrary operator. The transaction processing program PRA can be transferred by being recorded on a removable recording medium such as a magnetic disc, a magneto-optical disc, an optical disc, and a semiconductor memory or through communication via a network. The transaction processing program PRA may be stored in the main storage device 102.

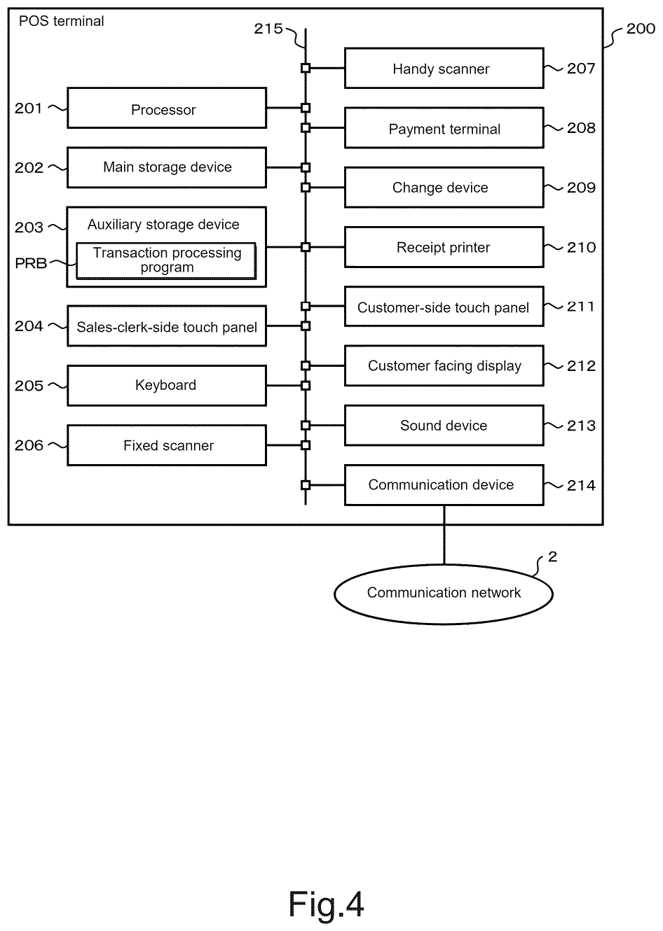

FIG. 4 is a block diagram showing a main circuit configuration of the POS terminal 200. The POS terminal 200 includes a processor 201, a main storage device 202, an auxiliary storage device 203, a sales-clerk-side touch panel 204, a keyboard 205, a fixed scanner 206, a handy scanner 207, a payment terminal 208, a change device 209, a receipt printer 210, a customer-side touch panel 211, a customer facing display 212, a sound device 213, a communication device 214, and a transmission path 215. As an example, the processor 201, the main storage device 202, the auxiliary storage device 203, the sales-clerk-side touch panel 204, the keyboard 205, the change device 209, the receipt printer 210, and the communication device 214 are provided to the body device 298. Further, as an example, the fixed scanner 206, the handy scanner 207, the payment terminal 208, the customer-side touch panel 211, the customer facing display 212, and the sound device 213 are provided to the scanner device 299. However, some components may be provided to the device opposite to the above. Further, some components such as a sales-clerk-side touch panel and a keyboard may be provided to both the body device 298 and the scanner device 299.

The schematic functions of the processor 201, the main storage device 202, the auxiliary storage device 203, the communication device 214, and the transmission path 215 are respectively equivalent to those of the processor 101, the main storage device 102, the auxiliary storage device 103, the communication device 104, and the transmission path 105. However, the auxiliary storage device 203 stores a transaction processing program PRB instead of the transaction processing program PRA. The transaction processing program PRB is an application program that describes a procedure of information processing of the processor 201 for transaction processing according to an operation of a sales clerk using a device included in the POS terminal 200.

The sales-clerk-side touch panel 204 is provided toward the side of the standing position of the sales clerk CL who operates the POS terminal 200 (hereinafter, referred to as a sales clerk side). The sales-clerk-side touch panel 204 displays a screen for presenting information to the sales clerk CL. Further, the sales-clerk-side touch panel 204 inputs an instruction by a touch operation of the sales clerk CL on the screen. The keyboard 205 includes a number of hard keys for an easy operation by the sales clerk CL from the sales clerk side. The keyboard 205 inputs an instruction of the sales clerk CL by pressing these hard keys.

The fixed scanner 206 includes a reading window facing the sales clerk side. The fixed scanner 206 images a product held up in front of the reading window and then recognizes barcode information indicated by the barcode formed on the product by image processing. The fixed scanner 206 then outputs the barcode information to the processor 201. Note that as the fixed scanner 206, a known device of another type that optically reads a barcode using reflection of a laser beam can also be used. Further, as the fixed scanner 206, a known device of a type that has a function of identifying a product by using an object recognition technology from an image of the product itself obtained by imaging the product can also be used. The handy scanner 207 is used in the hand of the sales clerk CL and optically reads a barcode facing the reading port. The handy scanner 207 outputs the barcode information indicated by the read barcode to the processor 201.

The payment terminal 208 reads data recorded on a payment card such as a credit card, a prepaid card, and an electronic money card. Further, the payment terminal 208 writes data to the payment card. The payment terminal 208 includes reading devices that correspond to IC reading, magnetic reding, and proximity communication reading of the credit card. The reading device for IC reading reads data stored in the integrated circuit (IC) provided the credit card through communication via electrical contacts. The reading device for magnetic reding reads data magnetically recorded on the magnetic stripe formed on the surface of the credit card using a magnetic head. In this way, the IC reading and magnetic reding involve contact between the payment terminal 208 and the credit card and are each an example of contact reading. The reading devices for IC reading and magnetic reding are each an example of a contact reading device. The reading device for proximity communication reading reads data stored in the integrated circuit (IC) provided in the credit card through wireless communication such as near field communication (NFC). In this way, the proximity communication reading is an example of non-contact reading. The reading device for proximity communication reading is an example of a non-contact reading device.

The change device 209 houses coins inserted through a coin insertion slot in an internal storage box while counting the amount of money. The change device 209 discharges coins housed in the storage box to a coin tray via the coin ejection slot. The change device 209 houses bills inserted through a bill insertion slot in an internal storage box while counting the amount of money. The change device 209 discharges bills housed in the storage box from a bill ejection slot. The bill ejection slot holds the discharged bill while being partially exposed to the outside.

The receipt printer 210 prints an image of a certificate such as a receipt, a receipt, and a sales slip on receipt paper. The receipt printer 210 discharges the receipt paper on which the image has been printed to the outside from a receipt outlet. Note that in the following, receipt paper on which an image of a receipt has been printed will be referred to as a paper receipt.

The customer-side touch panel 211 is provided toward the standing position side of the customer CU when a transaction product is registered by an operation of the sales clerk CL (hereinafter, referred to as a customer side). The customer-side touch panel 211 displays a screen for presenting information to a customer. Further, the customer-side touch panel 211 inputs an instruction by a touch operation of the customer CU on the screen.

The customer facing display 212 is provided toward the customer side. The customer facing display 212 displays a screen for presenting information to the customer CU. The customer facing display 212 is mainly adapted to display a character string and displays a simpler screen than the customer-side touch panel 211. The sound device 213 outputs sound and voice for various types of guidance and alarms. As the sound device, for example, various known sound devices such as a voice synthesis device and a buzzer can be used alone or in combination.

As basic hardware of the POS terminal 200, for example, hardware of another existing POS terminal can be used. In this case, the POS terminal 200 is generally transferred while the transaction processing program PRB is stored in the auxiliary storage device 203. However, hardware of the POS terminal 200 without the transaction processing program PRB stored in the auxiliary storage device 203 and the transaction processing program PRB may be individually transferred. The transaction processing program PRB may be written to the auxiliary storage device 203 in accordance with an operation of an arbitrary operator. Alternatively, hardware of the POS terminal 200 with another version of information processing program of the same type as the transaction processing program PRB stored in the auxiliary storage device 203 and the transaction processing program PRB may be individually transferred. The transaction processing program PRB may then be written to the auxiliary storage device 203 by replacing the information processing program that has already been stored. The transaction processing program PRB can be transferred by being recorded on a removable recording medium such as a magnetic disc, a magneto-optical disc, an optical disc, and a semiconductor memory or through communication via a network. The transaction processing program PRB may be stored in the main storage device 202.

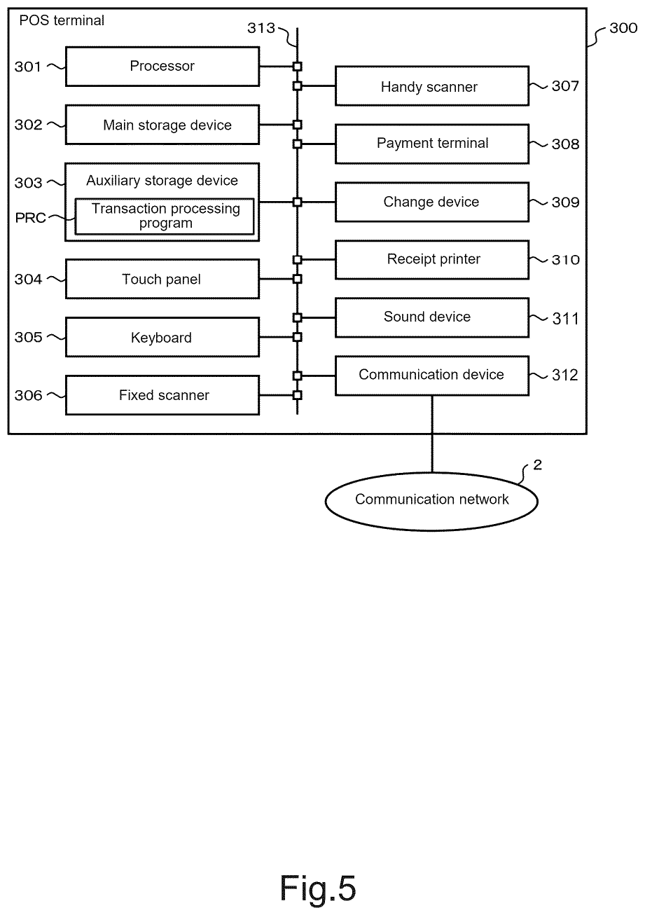

FIG. 5 is a block diagram showing a main circuit configuration of the POS terminal 300. The POS terminal 300 includes a processor 301, a main storage device 302, an auxiliary storage device 303, a touch panel 304, a keyboard 305, a fixed scanner 306, a handy scanner 307, a payment terminal 308, a change device 309, a receipt printer 310, a sound device 311, a communication device 312, and a transmission path 313.

The schematic functions of the processor 301, the main storage device 302, the auxiliary storage device 303, the communication device 312, and the transmission path 313 are respectively equivalent to those of the processor 101, the main storage device 102, the auxiliary storage device 103, the communication device 104, and the transmission path 105. However, the auxiliary storage device 303 stores a transaction processing program PRC instead of the transaction processing program PRA. The transaction processing program PRC is an application program that describes a procedure of information processing of the processor 301 for transaction processing according to an operation of a customer using a device included in the POS terminal 300.

The touch panel 304 is provided toward the standing position side of the customer CU who operates the POS terminal 300. The touch panel 304 displays a screen for presenting information to the customer CU. Further, the touch panel 304 inputs an instruction by a touch operation of the customer CU on the screen. The schematic functions of the keyboard 305, the fixed scanner 306, the handy scanner 307, the payment terminal 308, the change device 309, the receipt printer 310, and the sound device 311 are respectively equivalent to those of the keyboard 205, the fixed scanner 206, the handy scanner 207, the payment terminal 208, the change device 209, the receipt printer 210, and the sound device 213. However, the keyboard 305, the fixed scanner 306, the handy scanner 307, and the payment terminal 308 are provided for an easy operation by the customer CU and are mainly operated by the customer CU.

As basic hardware of the POS terminal 300, for example, hardware of another existing POS terminal of a full-self-service type can be used. In this case, the POS terminal 300 is generally transferred while the transaction processing program PRC is stored in the auxiliary storage device 303. However, hardware of the POS terminal 300 without the transaction processing program PRC stored in the auxiliary storage device 303 and the transaction processing program PRC may be individually transferred. The transaction processing program PRC may then be written to the auxiliary storage device 303 in accordance with an operation of an arbitrary operator. Alternatively, hardware of the POS terminal 300 with another version of information processing program of the same type as the transaction processing program PRC stored in the auxiliary storage device 303 and the transaction processing program PRC may be individually transferred. The transaction processing program PRC may then be written to the auxiliary storage device 303 by replacing the information processing program that has already been stored. The transaction processing program PRC can be transferred by being recorded on a removable recording medium such as a magnetic disc, a magneto-optical disc, an optical disc, and a semiconductor memory or through communication via a network. The transaction processing program PRC may be stored in the main storage device 302.

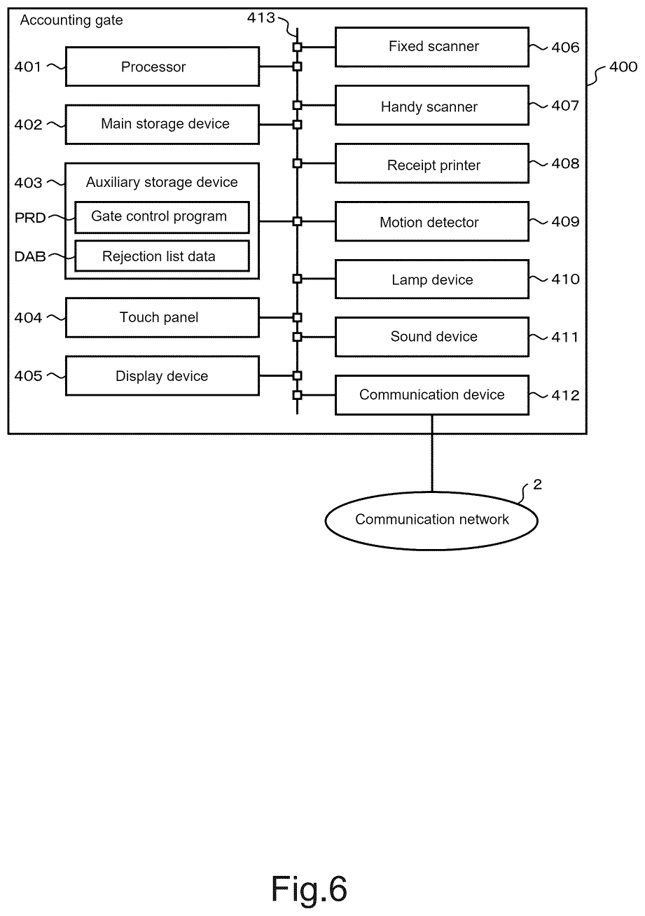

FIG. 6 is a block diagram showing a main circuit configuration of the accounting gate 400. The accounting gate 400 includes a processor 401, a main storage device 402, an auxiliary storage device 403, a touch panel 404, a display device 405, a fixed scanner 406, a handy scanner 407, a receipt printer 408, a motion detector 409, a lamp device 410, a sound device 411, a communication device 412, and a transmission path 413.

The schematic functions of the processor 401, the main storage device 402, the auxiliary storage device 403, the communication device 412, and the transmission path 413 are respectively equivalent to those of the processor 101, the main storage device 102, the auxiliary storage device 103, the communication device 104, and the transmission path 105. However, the auxiliary storage device 403 stores a gate control program PRD instead of the transaction processing program PRA. The gate control program PRD is an application program that describes a procedure of information processing of the processor 401 for gate control processing described below. Further, the auxiliary storage device 403 stores rejection list data DAB. The rejection list data DAB indicates a list of POS terminals determined as rejection targets in advance. Which of the POS terminals 200 and 300 is determined to be a rejection target may be determined as appropriate by, for example, an arbitrary setter such as the administrator of the product sales system 1. In this embodiment, the POS terminal 200 is a rejection target.

The touch panel 404 displays a screen for presenting information to an operator who performs an operation for accounting. Further, the touch panel 404 inputs an instruction by a touch operation of the operator on the screen. Note that the operator of the accounting gate 400 is typically the customer CU. However, the sales clerk CL is an operator of the accounting gate 400 in some cases.

The display device 405 displays a screen for presenting information to the customer CU who is about to pass through the checkout lane LA that the accounting gate 400 on which this display device 405 is provided faces. Note that in the following, when simply referring to the “checkout lane LA” in the description of the accounting gate 400, it refers to the checkout lane LA facing the corresponding accounting gate 400.

The fixed scanner 406 includes a reading window. The fixed scanner 406 recognizes barcode information indicated by the barcode held up in front of the reading window by image processing. The fixed scanner 406 then outputs the barcode information to the processor 401. Note that as the fixed scanner 406, a known device of another type that optically reads a barcode using reflection of a laser beam can also be used. Further, as the fixed scanner 406, a known device of a type that has a function of identifying a product by using an object recognition technology from an image of the product itself obtained by imaging the product can also be used.

The handy scanner 407 is used in the hand of the customer CU and optically reads a barcode facing the reading port. The handy scanner 407 outputs the barcode information indicated by the read barcode to the processor 401. The receipt printer 408 prints an image of a certificate such as a receipt, a receipt, and a sales slip on receipt paper. The receipt printer 408 discharges the receipt paper on which the image has been printed to the outside from a receipt outlet. That is, the receipt printer 408 is used to issue a paper receipt.

The motion detector 409 detects the customer CU who passes through the checkout lane LA. As the motion detector 409, a known detection device such as an optical sensor and an infrared sensor can be used as appropriate. That is, the motion detector 409 is an example of a first detection means. The lamp device 410 displays the permission status regarding the customer CU to pass through the checkout lane LA.

The sound device 411 outputs sound and voice for various types of guidance and alarms regarding the customer CU to pass through the checkout lane LA. As the sound device, for example, various known sound devices such as a voice synthesis device and a buzzer can be used alone or in combination.

The accounting gate 400 is generally transferred while the gate control program PRD is stored in the auxiliary storage device 403. However, hardware without the gate control program PRD stored in the auxiliary storage device 403 or with another version of application program of the same type stored in the auxiliary storage device 403 and the gate control program PRD may be individually transferred. The accounting gate 400 may then be configured by writing the gate control program PRD to the auxiliary storage device 403 in accordance with an operation of an arbitrary operator. The gate control program PRD can be transferred by being recorded on a removable recording medium such as a magnetic disc, a magneto-optical disc, an optical disc, and a semiconductor memory or through communication via a network. The gate control program PRD may be stored in the main storage device 402.

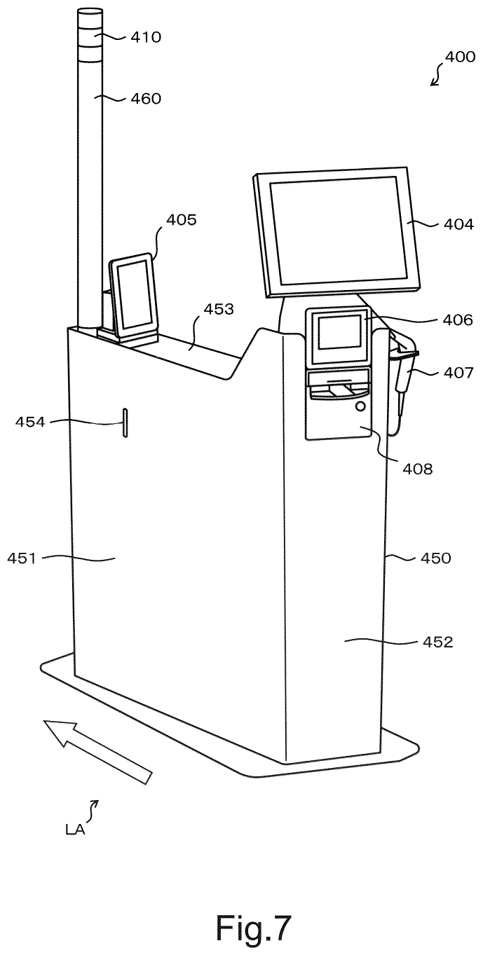

FIG. 7 is a perspective view showing the appearance of the accounting gate 400. Note that in FIG. 7, the same components as those shown in FIG. 6 are denoted by the same reference symbols. In the following description of FIG. 7, the right side and the left side in FIG. 7 will be referred to as the front side and the rear side. The accounting gate 400 includes a casing 450 having a substantially rectangular parallelepiped shape. The accounting gate 400 is installed with one side surface 451 of the casing 450 facing the checkout lane LA such that movement of the customer CU in the movement direction indicated by an arrow AR through the checkout lane LA is controlled. Hereinafter, the side surface of the casing 450 on the front side in the movement direction of the customer CU will be referred to as a front surface 452.

The casing 450 holds the fixed scanner 406 in posture that reads a barcode held over from the side of the front surface 452. The casing 450 holds, in the vicinity of an end portion of an upper surface 453 opposed to the front surface 452, the display device 405 in posture that allows the customer CU who is about to pass through the checkout lane LA to easily view the display surface of the display device 405. The casing 450 holds, below the fixed scanner 406, the receipt printer 408 in posture that discharges a receipt to the side of the front surface 452.

The touch panel 404 is mounted above the fixed scanner 406 in posture that allows the customer CU facing the front surface 452 to easily view the display surface. The handy scanner 407 is connected to the transmission path 413 provided inside the casing 450 through a cable and can be pulled out to the front side of the front surface 452 and used. Note that in FIG. 7, the handy scanner 407 is set in a holder. The motion detector 409 is provided inside the casing 450 to detect, through a slit 454 formed in the side surface 451, the customer CU who passes through the checkout lane LA. The lamp device 410 is mounted on the tip of a pole 460 erected on the upper surface 453 of the casing 450. Note that the processor 401, the main storage device 402, the auxiliary storage device 403, the sound device 411, and the communication device 412 in FIG. 6 are provided inside the casing 450.

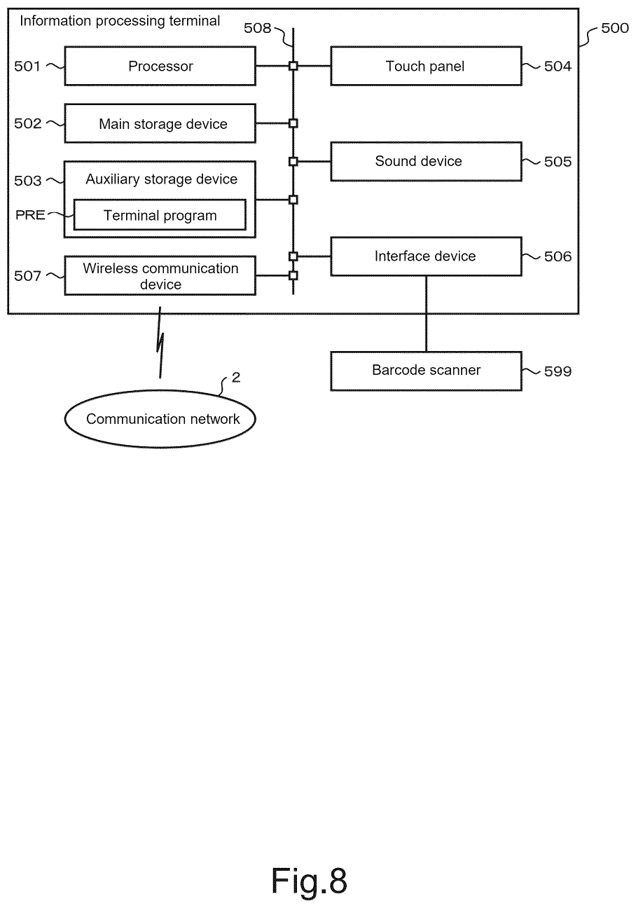

FIG. 8 is a block diagram showing a main circuit configuration of the information processing terminal 500. The information processing terminal 500 includes a processor 501, a main storage device 502, an auxiliary storage device 503, a touch panel 504, a sound device 505, an interface device 506, a wireless communication device 507, a transmission path 508, and the like.

The schematic functions of the processor 501, the main storage device 502, the auxiliary storage device 503, and the transmission path 508 are respectively equivalent to those of the processor 101, the main storage device 102, the auxiliary storage device 103, the communication device 104, and the transmission path 105. However, the auxiliary storage device 503 stores a terminal program PRE instead of the transaction processing program PRA. The terminal program PRE is an application program that describes a procedure of information processing of the processor 501 for causing the information processing terminal 500 to function as a user interface for registering a transaction product in the transaction processing apparatus 100.

The touch panel 504 displays a screen for presenting information to an operator. Further, the touch panel 504 inputs an instruction by a touch operation of the operator on the screen. The operator of the information processing terminal 500 is typically the customer CU. However, the sales clerk CL is an operator of the information processing terminal 500 in some cases. The sound device 505 outputs sound and voice for various types of guidance and alarms. As the sound device, for example, various known sound devices such as a voice synthesis device and a buzzer can be used alone or in combination.

An external device such as a barcode scanner 599 is connected to the interface device 506. The interface device 506 interfaces exchange of data with the external device connected thereto. As the interface device 506, an existing universal serial bus (USB) controller or the like can be used. The barcode scanner 599 is mounted on the cart CA and includes a reading window. The barcode scanner 599 recognizes barcode information indicated by the barcode held up in front of the reading window by image processing. The barcode scanner 599 then outputs the barcode information. Note that as the barcode scanner 599, a known device of another type that optically reads a barcode using reflection of a laser beam can also be used. Further, as the barcode scanner 599, a known device of a type that has a function of identifying a product by using an object recognition technology from an image of the product itself obtained by imaging the product can also be used. A barcode may be read using a camera included in the information processing terminal 500 instead of or in addition to the barcode scanner 599.

The wireless communication device 507 executes communication processing for wirelessly performing data communication via the communication network 2. As the wireless communication device 507, for example, an existing wireless communication device for a wireless LAN can be used. Note that a communication device wired connected to the communication network 2 may be used instead of or in addition to the wireless communication device 507.

As basic hardware of the information processing terminal 500, for example, hardware of an information processing apparatus of a table type is assumed to be used. The information processing terminal 500 is generally transferred while the terminal program PRE is stored in the auxiliary storage device 503. However, hardware without the terminal program PRE stored in the auxiliary storage device 503 or with another version of application program of the same type stored in the auxiliary storage device 503 and the terminal program PRE may be individually transferred. The information processing terminal 500 may then be configured by writing the terminal program PRE to the auxiliary storage device 503 in accordance with an operation of an arbitrary operator. The terminal program PRE can be transferred by being recorded on a removable recording medium such as a magnetic disc, a magneto-optical disc, an optical disc, and a semiconductor memory or through communication via a network. The terminal program PRE may be stored in the main storage device 502.

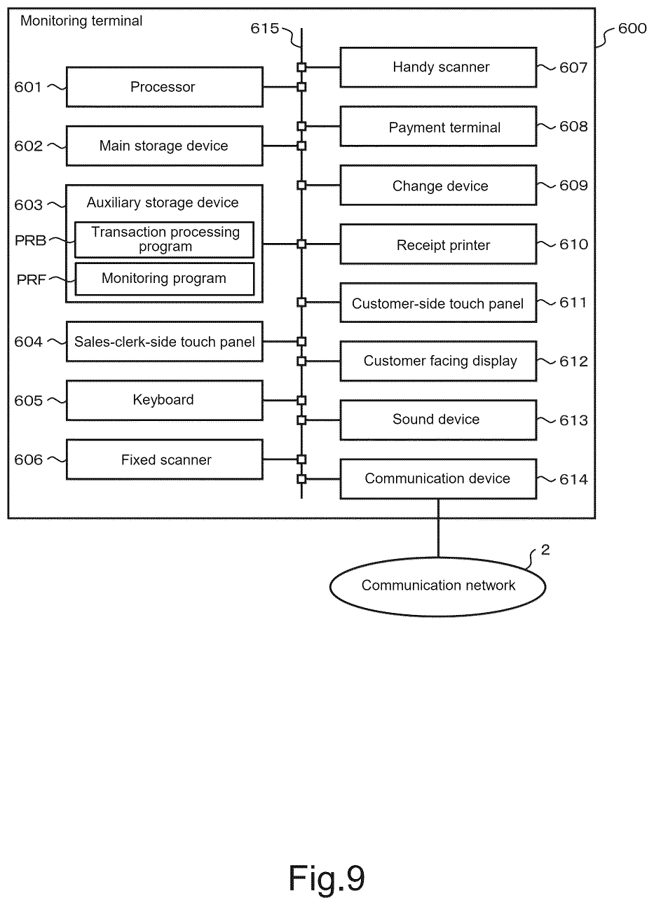

FIG. 9 is a block diagram showing a main circuit configuration of the monitoring terminal 600. The monitoring terminal 600 includes a processor 601, a main storage device 602, an auxiliary storage device 603, a sales-clerk-side touch panel 604, a keyboard 605, a fixed scanner 606, a handy scanner 607, a payment terminal 608, a change device 609, a receipt printer 610, a customer-side touch panel 611, a customer facing display 612, a sound device 613, a communication device 614, and a transmission path 615.

The schematic functions of the processor 601, the main storage device 602, the auxiliary storage device 603, the sound device 613, the communication device 614, and the transmission path 615 are respectively equivalent to those of the processor 101, the main storage device 102, the auxiliary storage device 103, the communication device 104, and the transmission path 105. Further, the functions of the sales-clerk-side touch panel 604, the keyboard 605, the fixed scanner 606, the handy scanner 607, the payment terminal 608, the change device 609, the receipt printer 610, the customer-side touch panel 611, the customer facing display 612, and the sound device 613 are respectively equivalent to those of the sales-clerk-side touch panel 204, the keyboard 205, the fixed scanner 206, the handy scanner 207, the payment terminal 208, the change device 209, the receipt printer 210, the customer-side touch panel 211, the customer facing display 212, and the sound device 213. That is, the monitoring terminal 600 has the same hardware configuration as that of the POS terminal 200.

However, the auxiliary storage device 603 stores a monitoring program PRF in addition to the transaction processing program PRB. The monitoring program PRF is an application program that describes a procedure of information processing for assisting the sales clerk CL who monitors illegal passage of the checkout lane LA. Thus, the monitoring terminal 600 is an apparatus having a configuration in which a monitoring support function is added to the POS terminal 200. However, the monitoring terminal 600 can be configured without having a transaction processing function. In this case, as basic hardware of the monitoring terminal 600, for example, a general-purpose computer device of various types such as a desktop type, a book type, and a tablet type can be used.

The monitoring terminal 600 is generally transferred while the transaction processing program PRB and the monitoring program PRF are stored in the auxiliary storage device 603. However, hardware without at least one of the transaction processing program PRB or the monitoring program PRF stored in the auxiliary storage device 403 or with another version of application program of the same type stored in the auxiliary storage device 603 and at least one of the transaction processing program PRB or the monitoring program PRF may be individually transferred. The monitoring terminal 600 may then be configured by writing the transaction processing program PRB and the monitoring program PRF to the auxiliary storage device 603 in accordance with an operation of an arbitrary operator. The transaction processing program PRB and the monitoring program PRF can be transferred by being recorded on a removable recording medium such as a magnetic disc, a magneto-optical disc, an optical disc, and a semiconductor memory or through communication via a network. The transaction processing program PRB and the monitoring program PRF may be stored in the main storage device 402.

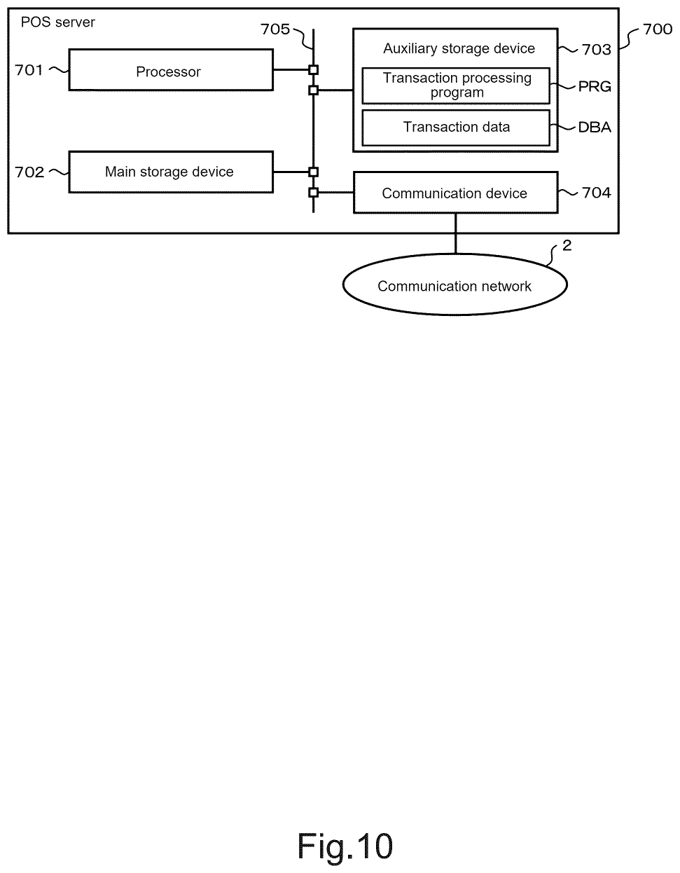

FIG. 10 is a block diagram showing a main circuit configuration of the POS server 700. The POS server 700 includes a processor 701, a main storage device 702, an auxiliary storage device 703, a communication device 704, and a transmission path 705. The schematic functions of the processor 701, the main storage device 702, the auxiliary storage device 703, the communication device 704, and the transmission path 705 are respectively equivalent to those of the processor 101, the main storage device 102, the auxiliary storage device 103, the communication device 104, and the transmission path 105.

However, the auxiliary storage device 703 stores a transaction management program PRG instead of the transaction processing program PRA. The transaction management program PRG is an application program that describes a procedure of information processing of the processor 701 for managing the transaction processed by the product sales system 1. Further, part of the storage region of the auxiliary storage device 703 is used to store a transaction database DBA. The transaction database DBA is a database that accumulates transaction data that indicates the content of a paid transaction for each transaction.

As basic hardware of the POS server 700, for example, a general-purpose server apparatus can be used. The POS server 700 is generally transferred while the transaction management program PRG is stored in the auxiliary storage device 703. However, hardware without the transaction management program PRG stored in the auxiliary storage device 703 or with another version of application program of the same type stored the auxiliary storage device 703 and the transaction management program PRG may be individually transferred. The POS server 700 may then be configured by writing the transaction management program PRG to the auxiliary storage device 703 in accordance with an operation of an arbitrary operator. The transaction management program PRG can be transferred by being recorded on a removable recording medium such as a magnetic disc, a magneto-optical disc, an optical disc, and a semiconductor memory or through communication via a network. The transaction management program PRG may be stored in the main storage device 702.

Next, the operation of the product sales system 1 configured as described above will be described. Note that the content of various types of processing described below is merely an example, and it is possible to change the order of part of the processing, omit part of the processing, or add other processing as appropriate. For example, in the following description, description of some processes is omitted in order to describe characteristic operations of this embodiment in an easy-to-understand manner. For example, in the case where some error occurs, a process to deal with the error is performed in some cases. However, description of such a process is omitted.

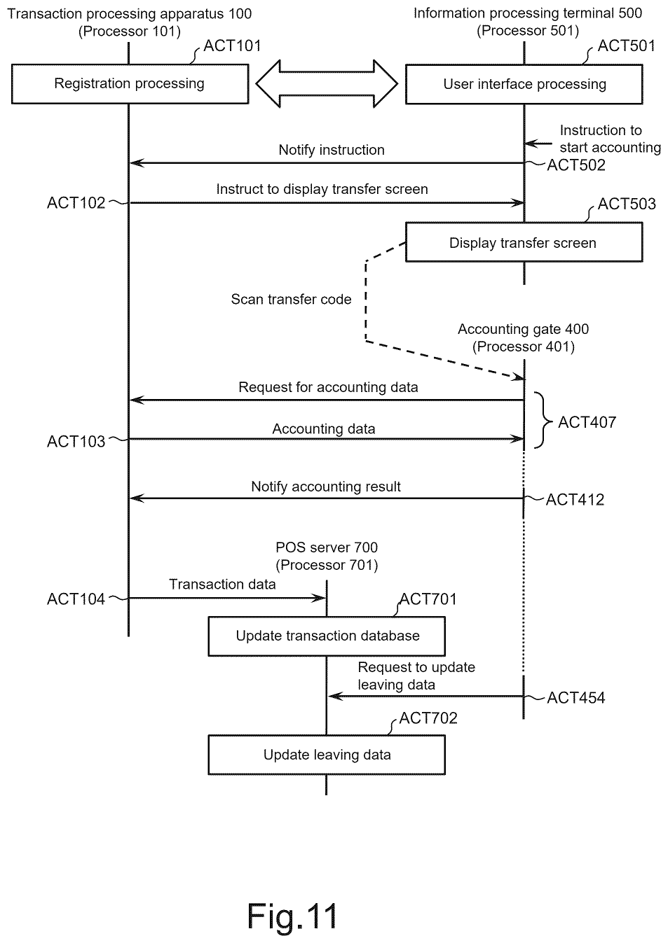

FIG. 11 is a sequence diagram relating to processing of a transaction using the information processing terminal 500. In the transaction processing apparatus 100 and the information processing terminal 500, the processor 101 and the processor 501 perform registration processing as ACT101 and user interface processing as ACT501 in cooperation with each other. The processor 101 registers a product to be purchased by the customer CU as a transaction product while using the information processing terminal 500 as a user interface terminal to receive an instruction from the customer CU and generates transaction data indicating a list of transaction products. Note that the registration processing is, for example, processing of causing the information processing terminal 500 to read the barcode of a product to be purchased by the customer CU or adding, as a transaction product, a product specified by the customer CU by operating a preset key for specifying a product displayed on the information processing terminal 500, which is set in advance.

When the customer CU performs a predetermined operation for instructing to start accounting using the information processing terminal 500, the processing of the processor 501 in the information processing terminal 500 proceeds to ACT502. In ACT502, the processor 501 notifies the transaction processing apparatus 100 of the instruction to start accounting.

When the processor 101 in the transaction processing apparatus 100 is notified of the instruction to start accounting, the processing of the processor 101 proceeds to ACT102. In ACT102, the processor 101 instructs the information processing terminal 500 to display a transfer screen.

When the processor 501 in the information processing terminal 500 is instructed to display a transfer screen, the processing of the processor 501 proceeds to ACT503. In ACT503, the processor 501 displays a transfer screen on the touch panel 504. The transfer screen is a screen for transferring the function as a user interface terminal regarding the transaction being processed from the information processing terminal 500 to the accounting gate 400. The transfer screen includes, for example, a two-dimensional code indicating transfer data for the accounting gate 400 to request accounting data based on transaction data from the transaction processing apparatus 100 (hereinafter, referred to as a transfer code).

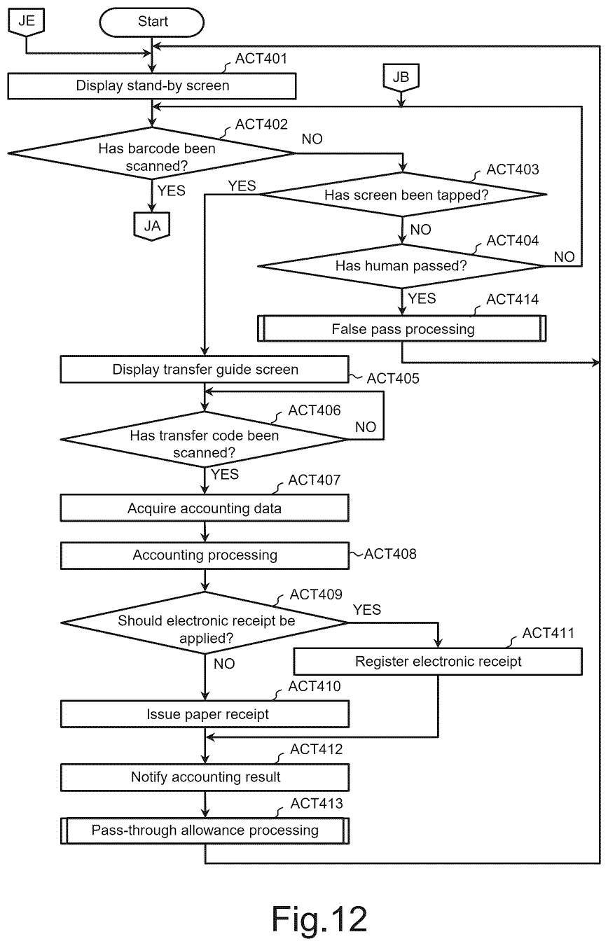

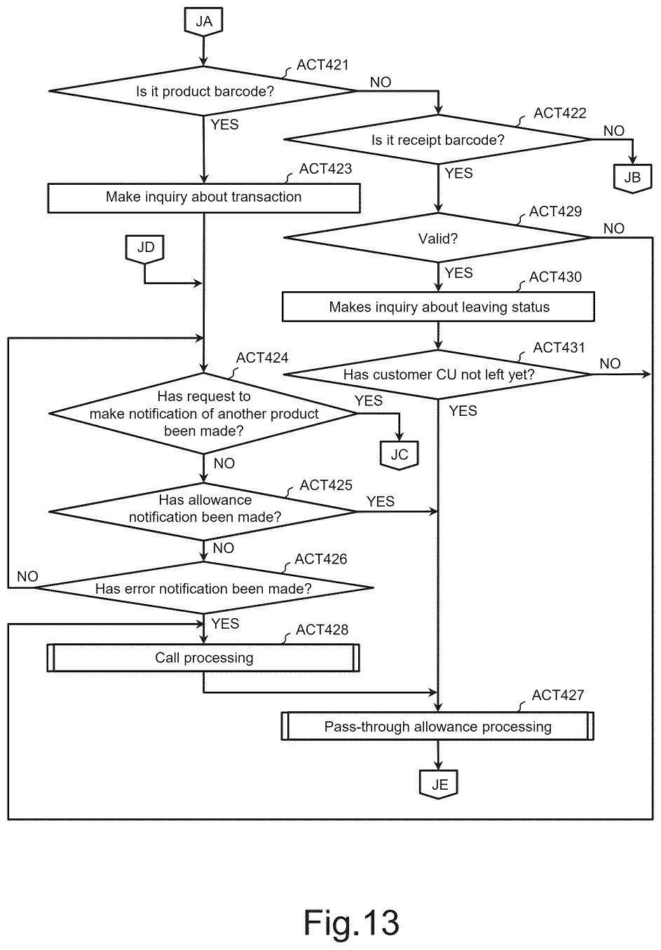

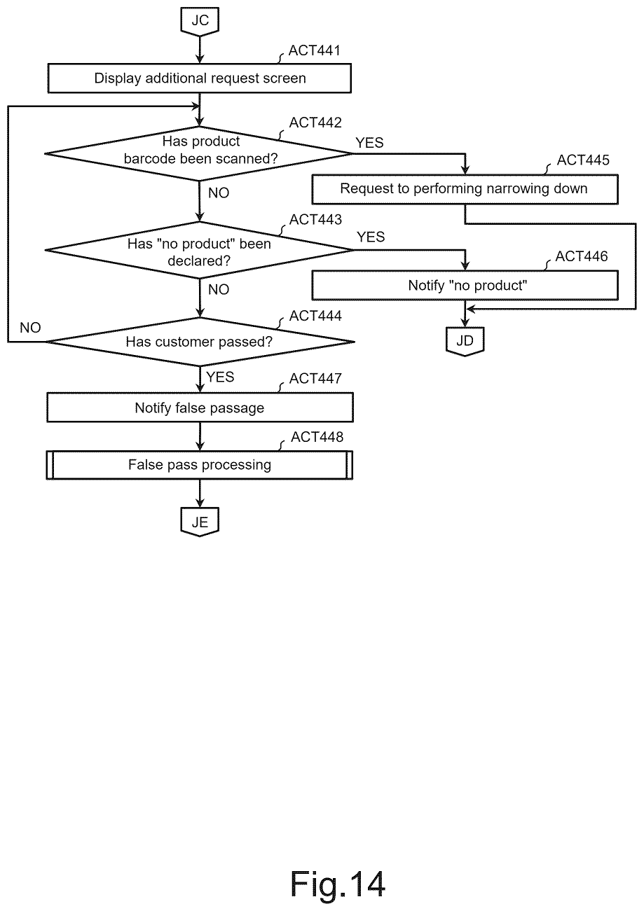

Meanwhile, the processor 401 in the accounting gate 400 executes gate control processing according to the gate control program PRD in the operation state that allows it to be used by the customer CU. FIG. 12, FIG. 13, and FIG. 14 are each a flowchart of gate control processing. In ACT401, the processor 401 displays a stand-by screen on the touch panel 404 and the display device 405. The stand-by screen is a screen for guiding the operation to be performed by the customer CU in the state of standing by for an operation of the customer CU.

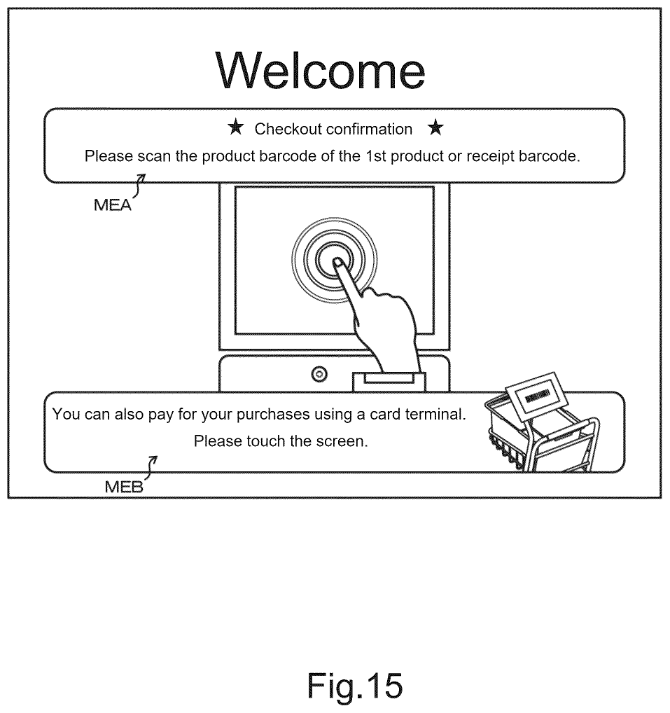

FIG. 15 is a screen showing an example of a stand-by screen displayed on the touch panel 404. Note that the stand-by screen and various screen described below illustrate main display objects, and some display objects are omitted in some cases. For example, an image to give the user an idea of the operation to be performed by him/her is included in the screen in some cases. The content of the various screens may be determined as appropriate by, for example, the specification maker of the product sales system 1.

The stand-by screen shown in FIG. 15 includes text messages MEA and MEB. The text message MEA guides the customer CU who has completed a payment for the transaction and is about to leave the store to scan the product barcode of one of the transaction products or receipt barcode. The text message MEB informs the customer CU of that he/she should touch the screen of the touch panel 404 in order to start the payment for the transaction products registered using the information processing terminal 500. Note that the product barcode is a barcode that is displayed on a product and indicates barcode information including a product code as an identifier of the product. The receipt barcode is a barcode that indicates barcode information including a transaction code as an identifier of the transaction and is displayed on a receipt. As the product barcode and the receipt barcode, typically, one-dimensional barcodes are used. However, as the product barcode and the receipt barcode, optically readable codes of another type such as a two-dimensional code may be used.

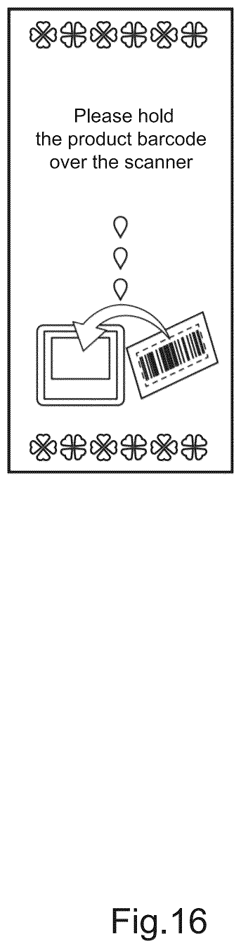

FIG. 16 is a screen showing an example of a stand-by screen displayed on the display device 405. The stand-by screen shown in FIG. 16 is a screen that guides the customer CU who has completed a payment for the transaction and is about to leave the store to scan the product barcode of one of the transaction products.

In ACT402 in FIG. 12, the processor 401 checks whether or not a barcode has been scanned. When the corresponding event cannot be confirmed, the processor 401 determines it as NO and the processing of the processor 401 proceeds to ACT403. In ACT403, the processor 401 checks whether or not the screen of the touch panel 404 has been tapped. When the corresponding event cannot be confirmed, the processor 401 determines it as NO and the processing of the processor 401 proceeds to ACT404. In ACT404, the processor 401 checks whether or not a human has passed through the checkout lane LA. When the corresponding event cannot be confirmed, the processor 401 determines it as NO and the processing of the processor 401 returns to ACT402. Note that the “checkout lane LA” here and the “checkout lane LA” in the following description refer to the checkout lane LA that the accounting gate 400 that is the subject of the description faces. In this way, in ACT402 to ACT404, the processor 401 stands by until a barcode is scanned, a screen is tapped, or a human passes.

The customer CU using the information processing terminal 500 that displays the transfer screen on the touch panel 504 as described above arbitrary selects, if a plurality of accounting gates 400 is installed, one of the accounting gates 400, which displays the stand-by screen, and touches the screen of the touch panel 504 of the selected accounting gate 400. As a result, when a tap of the touch panel 504 is detected, the processor 401 determines it as YES in ACT403 and the processing of the processor 401 proceeds to ACT405.

In ACT405, the processor 401 displays a transfer guide screen on the touch panel 404 and the display device 405. The transfer guide screen is a screen that guides the customer CU to cause the handy scanner 407 to read the transfer code included in the transfer screen displayed on the touch panel 504 in the information processing terminal 500 as described above. In ACT406, the processor 401 stands by until a transfer code is scanned.

The customer CU touches the screen of the touch panel 504 as described above and then causes the reading port of the handy scanner 407 to face the transfer code. As a result, the handy scanner 407 reads the transfer code and outputs the barcode information indicated by the transfer code to the processor 401. In response thereto, the processor 401 determines it as YES in ACT406 and the processing of the processor 401 proceeds to ACT407. Note that the transfer code may be read by the fixed scanner 406. That is, for example, if the information processing terminal 500 can be detached from the cart CA or a portable information processing apparatus is used as the information processing terminal 500, the touch panel 504 of the information processing terminal 500 may be caused to face the fixed scanner 406. The transfer guide screen is desired to display the content that informs the customer CU of the assumed reading format of the transfer code.

In ACT407, the processor 401 acquires accounting data on the basis of the transfer data indicated by the barcode information output from the handy scanner 407. That is, as shown in FIG. 11, the processor 401 requests accounting data to the transaction processing apparatus 100. When accounting data is requested from the accounting gate 400 to the processor 101 in the transaction processing apparatus 100, the processing of the processor 101 proceeds to ACT103.

In ACT103, the processor 101 transmits predetermined accounting data for account and payment according to the transaction content indicated by the transaction data to the accounting gate 400 that is a requestor. In this regard, in ACT407, the processor 401 in the accounting gate 400 captures the accounting data that is transmitted in this way and received by the communication device 412.

When the accounting data is acquired in this way, the processing of the processor 401 proceeds to ACT408 in FIG. 12. In ACT408, the processor 401 performs accounting processing based on the acquired accounting data. That is, the processor 401 performs, for example, account processing for determining the payment amount regarding the corresponding transaction on the basis of the acquired accounting data. This account processing may be, for example, processing similar to that performed by an accounting machine of an existing semi-self-service POS system. The processor 401 then performs, for example, payment processing for paying for the payment amount determined as described above. The payment processing is assumed to be performed by applying electronic money provided independently by the company operating the store as an example. In this case, the identifier of the customer CU is acquired, for example, at the start of use of the information processing terminal 500, and the payment is made using the electronic money balance associated with this identifier. However, for the payment in the accounting gate 400, various payment methods such as credit payment, code payment, prepaid payment, point payment, gift certificate payment, and cash payment may be used as appropriate. Further, for the payment in the accounting gate 400, electronic money payment provided by a payment provider other than the company operating the store may be used. Note that depending on the payment method to be made available, an additional device that is necessary for the payment using this payment method and is not shown in FIG. 6 is provided in some cases.

In ACT409, the processor 401 checks whether or not an electronic receipt should be applied. If the identifier of the customer CU is acquired as described above, the processor 401 checks whether or not a setting to apply an electronic receipt is made in advance for the customer CU identified by this identifier. The processor 401 may cause the customer CU to determine whether or not an electronic receipt is to be applied and may check whether or not an electronic receipt should be applied in accordance with the determination. When it is not confirmed that an electronic receipt should be applied, the processor 401 then determines it as NO and the processing of the processor 401 proceeds to ACT410.

In ACT410, the processor 401 issues a paper receipt that indicates the content of the transaction, the accounting result, and the receipt barcode. That is, the processor 401 generates, for example, a receipt image that indicates the content of the transaction, the accounting result, and the payment completion code, and causes the receipt printer 408 to print the receipt image. As a result, a paper receipt created by printing a receipt image on receipt paper by the receipt printer 408 is issued.

Meanwhile, if it is confirmed that an electronic receipt should be applied, the processor 401 determines it as YES in ACT409 and the processing of the processor 401 proceeds to ACT411. In ACT411, the processor 401 registers, in the electronic receipt server 3, an electronic receipt including the content of the transaction, the accounting result, and the receipt barcode. That is, the processor 401 transmits, to the electronic receipt server 3, predetermined request data for requesting to register an electronic receipt with a notification of the content of the transaction, the accounting result, and the payment completion code. Upon receiving this request data, the electronic receipt server 3 causes an electronic receipt screen indicating the notified content of the transaction, accounting result, and receipt barcode to be viewable from an arbitrary information terminal.

When ACT410 or ACT411 is finished, the processing of the processor 401 proceeds to ACT412 in either case. In ACT412, the processor 401 notifies the transaction processing apparatus 100 of the result of accounting processing. In response to this notification, the processing of the processor 101 in the transaction processing apparatus 100 proceeds to ACT104 in FIG. 11.

In ACT104, the processor 401 transmits transaction data relating to the transaction to be processed this time to the POS server 700. The transaction data may be similar to transaction data in an existing POS system. That is, the transaction data may include a transaction header, item data, combined discount data, customer data, closing data, credit data, and the like. Note that the item data is data indicating a list of transaction products and corresponds to list data. What data is included in the transaction data may be determined as appropriate by, for example, the specification maker of the product sales system 1. However, the transaction data is data that allows at least what kind of product was traded in the corresponding transaction to be determined. Further, the processor 401 causes the transaction data to include leaving data indicating the leaving status of the customer CU from the store as a state representing that he/she has not left yet.

Upon receiving the above transaction data, the processing of the processor 701 in the POS server 700 proceeds to ACT701. In ACT701, the processor 701 updates the transaction database DBA to include the above transaction data. Thus, the transaction database DBA is data that accumulates transaction data that includes item data as list data for each paid transaction, and the auxiliary storage device 703 is an example of a storage means.

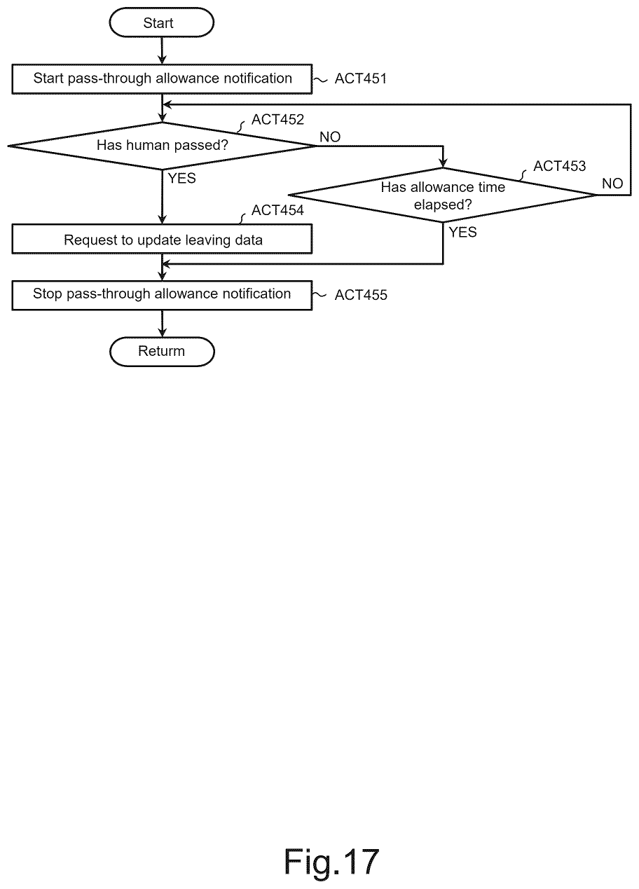

Incidentally, after notifying the accounting result in ACT412 in FIG. 12, the processing of the processor 401 in the accounting gate 400 proceeds to ACT413. In ACT413, the processor 401 performs pass-through allowance processing. FIG. 17 is a flowchart of the pass-through allowance processing. In ACT451, the processor 401 starts pass-through allowance notification. The pass-through allowance notification is a notification for causing the customer CU and people around him/her to recognize that he/she is allowed to pass through the checkout lane LA. The processor 401 causes, for example, the lamp device 410 to be lit blue for the pass-through allowance notification. The processor 401 causes, for example, the sound device 411 to output a voice message such as “Please pass through the gate” for the pass-through allowance notification. Alternatively, the processor 401 may cause, for example, the sound device 411 to perform another operation such as outputting a predetermined notification sound for the pass-through allowance notification. However, the processor 401 may execute only some of these for the pass-through allowance notification.

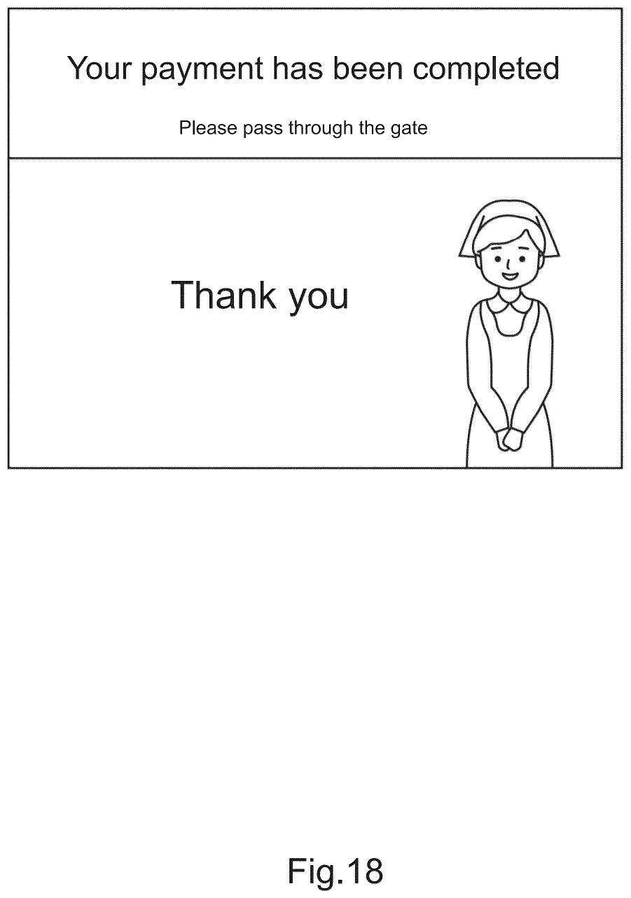

Further, the processor 401 displays, for example, a first guidance screen on the touch panel 404, in addition to the above for the pass-through allowance notification. The processor 401 displays, for example, a second guidance screen on the display device 405, in addition to the above for the pass-through allowance notification. FIG. 18 s a diagram showing an example of the first guidance screen. The first guidance screen shown in FIG. 18 includes a text message indicating that the customer CU is allowed to pass through the checkout lane LA because his/her payment has been completed.

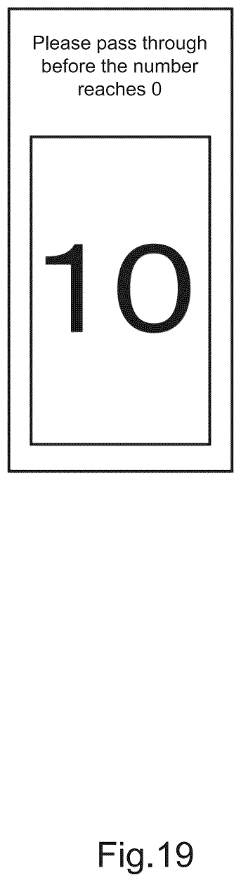

FIG. 19 is a diagram showing an example of the second guidance screen. The second guidance screen shown in FIG. 19 includes a text message indicating that there is a time limit on the time when the customer CU is allowed to pass through the checkout lane LA and a number indicating the remaining time when the customer CU is allowed to pass through the checkout lane LA. The second guidance screen shown in FIG. 19 is an example in which the remaining time is 10 seconds, and the number “10” indicates the remaining time. The processor 401 updates the number indicating the remaining time each time the remaining time changes, regarding the second guidance screen. This second guidance screen allows the customer CU to recognize the remaining time when he/she is allowed to pass through the checkout lane LA. On the basis of this screen, the customer CU can determine whether or not he/she should hurry through the checkout lane LA.

The various displays and various sound outputs shown here are all examples of notifying that the customer CU is allowed to pass through the checkout lane LA. Thus, the touch panel 404, the display device 405, the lamp device 410, and the sound device 411 are examples of a notification means and a third notification means.

The processing of the processor 401 proceeds to ACT452 while the pass-through allowance notification is being made. In ACT452, the processor 401 checks whether or not a human has passed through the checkout lane LA. When the corresponding event cannot be confirmed, the processor 401 determines it as NO and the processing of the processor 401 proceeds to ACT453. In ACT453, the processor 401 checks whether or not predetermined allowance time has elapsed since the pass-through allowance notification started in ACT451. When the corresponding event cannot be confirmed, the processor 401 determines it as NO and the processing of the processor 401 returns to ACT452. In this way, in ACT452 and ACT453, the processor 401 stands by until a human passes or the allowance time elapses.

When the customer CU passes through the checkout lane LA before the allowance time elapses and thus the motion detector 409 detects that a human passes, the processor 401 determines it as YES in ACT452 and the processing of the processor 401 proceeds to ACT454. In ACT454, the processor 401 requests the POS server 700 to update the leaving data. Upon receiving this request, the processing of the processor 701 in the POS server 700 proceeds to ACT702 in FIG. 11. Note that this request to update leaving data may be made by the processor 601 to the POS server 700 upon receiving a notification of leaving by the processor 401. In ACT702 in FIG. 11, the processor 701 updates the leaving data included in the transaction data included in the transaction database DBA in ACT701 to the state indicating that the leaving has been completed.

When completing the notification in ACT454 in FIG. 17, the processing of the processor 401 in the accounting gate 400 proceeds to ACT455. Note that when the allowance time has elapsed without confirming that the customer CU has passed through the checkout lane LA, the processing of the processor 401 determines it as YES in ACT453 and proceeds to ACT455 without through ACT454. For example, the customer CU does not pass through the checkout lane LA and returns to the sales floor or the like in some cases even after the payment is completed, and the processor 401 determines it as YES in ACT453 in such a case. In ACT455, the processor 401 stops the pass-through allowance notification. The processor 401 then ends the pass-through allowance processing, and the processing of the processor 401 returns to ACT401 in FIG. 12 and prepares for the next customer CU.

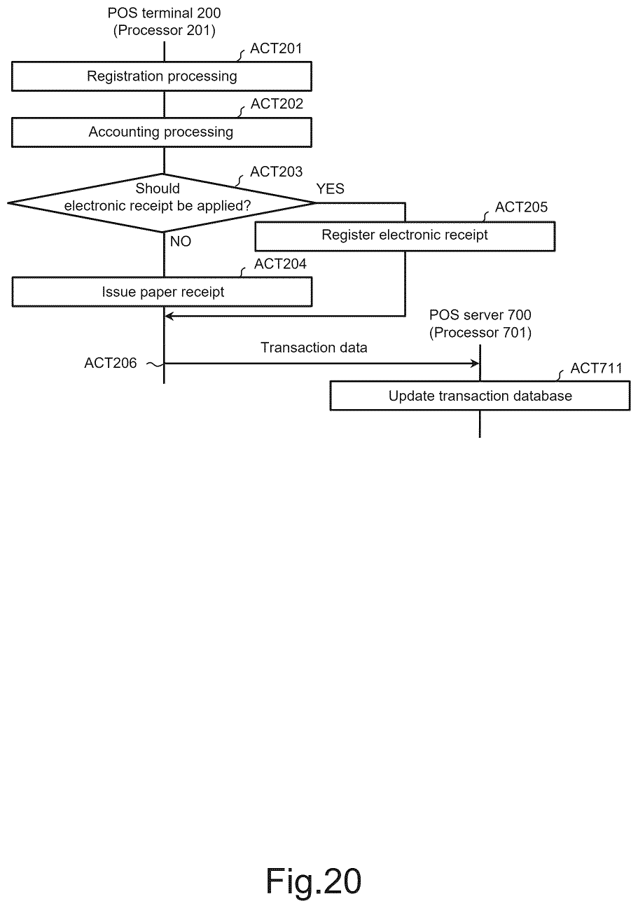

FIG. 20 is a sequence diagram relating to processing of a transaction using the POS terminal 200. Upon receiving an instruction to start registration by a predetermined operation of the sales clerk CL, the processing of the processor 201 in the POS terminal 200 proceeds to ACT201. In ACT201, the processor 201 registers a product to be purchased by the customer CU as a transaction product in accordance with an operation of the sales clerk CL using various devices of the POS terminal 200 and generates transaction data indicating a list of transaction products. When the sales clerk CL declares that the registration has been completed, the processing of the processor 201 then proceeds to ACT202.

In ACT202, the processor 201 performs accounting processing for account and payment according to the transaction content indicated by the transaction data generated in ACT201. That is, the processor 201 performs, for example, account processing for determining the payment amount regarding the corresponding transaction on the basis of the generated transaction data. The processor 201 then performs, for example, payment processing for paying for the payment amount determined as described above. For the payment processing, various payment methods such as credit payment, code payment, prepaid payment, point payment, gift certificate payment, and cash payment may be used as appropriate. The above registration and accounting processing may be similar to those performed in, for example, an existing POS terminal of a face-to-face type.

In ACT203, the processor 201 checks whether or not an electronic receipt should be applied. If the identifier of the customer CU is acquired during the above registration processing or accounting processing, the processor 201 checks whether or not a setting to apply an electronic receipt is made in advance for the customer CU identified by this identifier. The processor 201 may cause the customer CU or the sales clerk CL to determine whether or not an electronic receipt is to be applied and may check whether or not an electronic receipt should be applied in accordance with the determination. When it is not confirmed that an electronic receipt should be applied, the processor 201 then determines it as NO and the processing of the processor 201 proceeds to ACT204.

In ACT204, the processor 201 issues a paper receipt that indicates the content of the transaction, the accounting result, and the receipt barcode. That is, the processor 201 generates, for example, a receipt image that indicates the content of the transaction, the accounting result, and the like, and causes the receipt printer 210 to print the receipt image. As a result, a paper receipt created by printing a receipt image on receipt paper by the receipt printer 210 is issued.

Meanwhile, if it is confirmed that an electronic receipt should be applied, the processor 201 determines it as YES in ACT203 and the processing of the processor 201 proceeds to ACT205. In ACT205, the processor 201 registers, in the electronic receipt server 3, an electronic receipt including the content of the transaction, the accounting result, and the receipt barcode. That is, the processor 201 transmits, to the electronic receipt server 3, predetermined request data for requesting to register an electronic receipt with a notification of the content of the transaction, the accounting result, and the like. Upon receiving this request data, the electronic receipt server 3 causes an electronic receipt screen indicating the notified content of the transaction, accounting result, and receipt barcode to be viewable from an arbitrary information terminal.

When ACT204 or ACT205 is finished, the processing of the processor 201 proceeds to ACT206 in either case. In ACT206, the processor 201 transmits the transaction data relating to the transaction processed this time to the POS server 700. The transaction data may be similar to transaction data in an existing POS system. That is, the transaction data may include a transaction header, item data, combined discount data, customer data, closing data, credit data, and the like. Note that the item data is data indicating a list of transaction products. What data is included in the transaction data may be determined as appropriate by, for example, the specification maker of the product sales system 1. However, the transaction data is data that allows at least what kind of product was traded in the corresponding transaction to be determined. In this embodiment, the customer CU for the transaction to be processed by the POS terminal 200 is not subjected to leaving control by the accounting gate 400, and an operation is performed independently of the accounting gate 400. For this reason, the processor 201 does not cause the transaction data to include leaving data. That is, as the POS terminal 200, an existing POS terminal of a face-to-face type may be used as it is.

Upon receiving the above transaction data, the processing of the processor 701 of the POS server 700 proceeds to ACT711. In ACT711, the processor 701 updates the transaction database DBA to include the above transaction data.

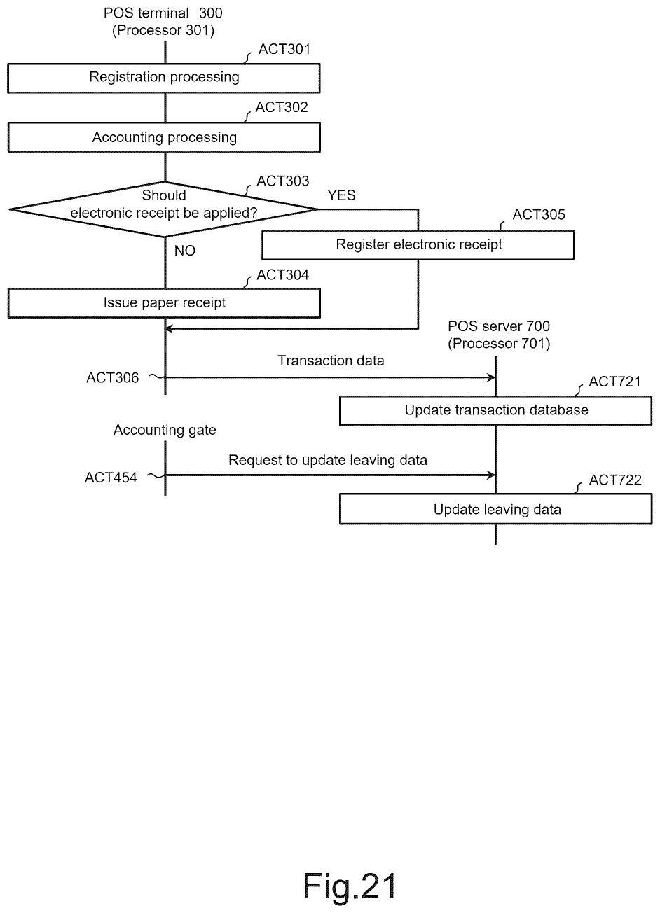

FIG. 21 is a sequence diagram relating to processing of a transaction using the POS terminal 300. Upon receiving an instruction to start registration by a predetermined operation of the customer CU, the processing of the processor 301 in the POS terminal 300 proceeds to ACT301. In ACT301, the processor 301 registers a product to be purchased by the customer CU as a transaction product in accordance with an operation of the customer CU using various devices of the POS terminal 300 and generates transaction data indicating a list of transaction products. For example, the processor 301 registers, as a transaction product, a product specified by causing the fixed scanner 306 or the handy scanner 307 to read the barcode of the product by the customer CU or operating a preset key that is displayed on the touch panel 304 or included in the keyboard 305, which is associated with the product in advance, by the customer CU. When the customer CU declares that the registration has been completed, the processing of the processor 301 then proceeds to ACT302.

In ACT302, the processor 301 performs accounting processing for account and payment according to the transaction content indicated by the transaction data generated in ACT301. That is, the processor 301 performs, for example, account processing for determining the payment amount regarding the corresponding transaction on the basis of the generated transaction data. The processor 301 then performs, for example, payment processing for paying for the payment amount determined as described above. For the payment processing, various payment methods such as credit payment, code payment, prepaid payment, point payment, gift certificate payment, and cash payment may be used as appropriate. The above registration and accounting processing may be similar to those performed in, for example, an existing POS terminal of a face-to-face type.

In ACT303, the processor 301 checks whether or not an electronic receipt should be applied. If the identifier of the customer CU is acquired during the above registration processing or accounting processing, the processor 301 checks whether or not a setting to apply an electronic receipt is made in advance for the customer CU identified by this identifier. The processor 301 may cause the customer CU to determine whether or not an electronic receipt is to be applied and may check whether or not an electronic receipt should be applied in accordance with the determination. When it is not confirmed that an electronic receipt should be applied, the processor 301 then determines it as NO and the processing of the processor 301 proceeds to ACT304.

In ACT304, the processor 301 issues a paper receipt that indicates the content of the transaction, the accounting result, and the receipt barcode. That is, the processor 301 generates, for example, a receipt image indicating the content of the transaction, the accounting result, and the receipt barcode and causes the receipt printer 310 to print the receipt image. As a result, a paper receipt created by printing a receipt image on receipt paper by the receipt printer 310 is issued.

Meanwhile, if it is confirmed that an electronic receipt should be applied, the processor 301 determines it as YES in ACT303 and the processing of the processor 301 proceeds to ACT305. In ACT305, the processor 301 registers, in the electronic receipt server 3, an electronic receipt including the content of the transaction, the accounting result, and the receipt barcode. That is, the processor 301 transmits, to the electronic receipt server 3, predetermined request data for requesting to register an electronic receipt with a notification of the content of the transaction, the accounting result, and the receipt barcode. Upon receiving this request data, the electronic receipt server 3 causes an electronic receipt screen indicating the notified content of the transaction, accounting result, and receipt barcode to be viewable from an arbitrary information terminal.

When ACT304 or ACT305 is finished, the processing of the processor 301 proceeds to ACT306 in either case. In ACT306, the processor 301 transmits the transaction data relating to the transaction processed this time to the POS server 700. The transaction data may be similar to transaction data in an existing POS system. That is, the transaction data may include a transaction header, item data, combined discount data, customer data, closing data, credit data, and the like. Note that the item data is data indicating a list of transaction products. What data is included in the transaction data may be determined as appropriate by, for example, the specification maker of the product sales system 1. However, the transaction data is data that allows at least what kind of product was traded in the corresponding transaction to be determined. In this embodiment, the customer CU for the transaction to be processed by the POS terminal 300 is subjected to leaving control by the accounting gate 400. For this reason, the processor 301 causes the transaction data to include leaving data indicating that the customer CU has not left yet.

Upon receiving the above-transaction data, the processing of the processor 701 in the POS server 700 proceeds to ACT721. In ACT721, the processor 701 updates the transaction database DBA to include the above transaction data.

In the case where the customer CU who has made a payment at the accounting gate 400 but has not passed through the checkout lane LA within the allowance time as described above attempts to leave the store without purchasing an additional product, he/she causes the fixed scanner 406 or the handy scanner 407 of an arbitrary accounting gate 400 in the stand-by state to read the paper receipt issued by the accounting gate 400 or the receipt barcode shown on the electronic receipt screen. The fixed scanner 406 and the handy scanner 407 are also referred to as a reading means for reading a receipt barcode that is an example of an optically readable code.

The customer CU who has completed the payment at the POS terminal 300 causes the fixed scanner 406 or the handy scanner 407 of an arbitrary accounting gate 400 in the stand-by state to read the paper receipt issued by the POS terminal 300 or the receipt barcode shown on the electronic receipt screen. Note that, in the case where it is difficult to cause the fixed scanner 406 or the handy scanner 407 to read the receipt barcode due to various circumstances such as a case where the customer CU has lost the paper receipt issued by the accounting gate 400 or the POS terminal 300 and a case where the electronic receipt screen cannot be displayed because he/she does not own a smartphone or the like, the customer CU can also use a function to confirm leaving by checking the transaction product. When using this function, the customer CU causes the fixed scanner 406 or the handy scanner 407 to read the product barcode of one of the paid transaction products. Since the product barcode includes a product code as an identifier of a product, each of the fixed scanner 406 and the handy scanner 407 is an example of an acquisition means for acquiring an identifier of a product in accordance with an operation of the customer CU.

Upon reading the barcode, the fixed scanner 406 or the handy scanner 407 notifies the processor 401 of the barcode information indicated by the barcode. As a result, the processor 401 determines it as YES in ACT402 in FIG. 12 and the processing of the processor 401 proceeds to ACT421 in FIG. 13.

In ACT421, the processor 401 checks whether or not the read barcode is a product barcode. When the corresponding event cannot be confirmed, the processor 401 then determines it as NO and the processing of the processor 401 proceeds to ACT422. In ACT422, the processor 401 checks whether or not the read barcode is a receipt barcode. When the corresponding event cannot be confirmed, the processor 401 determines it as NO and the processing of the processor 401 returns to the stand-by state in ACT402 to ACT404 in FIG. 5. At this time, the processor 401 may also perform a guidance operation such as displaying a screen for guiding the customer CU to cause the product barcode or the receipt barcode to be read.

When the product barcode has been read as described above, the processor 401 determines it as YES in ACT421 and the processing of the processor 401 proceeds to ACT423. In ACT423, the processor 401 makes an inquiry to the POS server 700 about the transaction with a notification of the product code included in the barcode information acquired by reading the product barcode. By executing the information processing based on the gate control program PRD by the processor 401 in this way, the computer that includes the processor 401 as the central part functions as a first notification means.

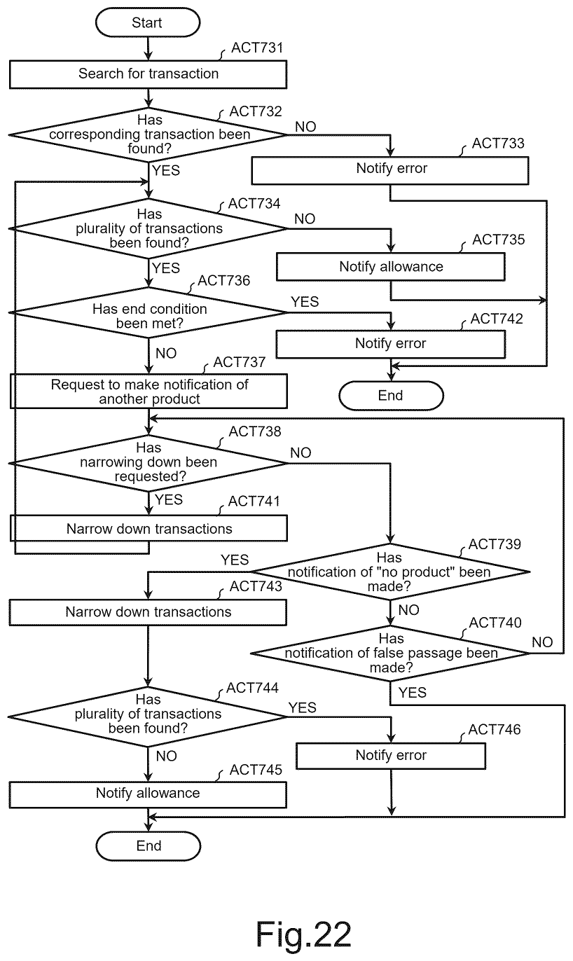

Upon receiving the above inquiry about a transaction, the processor 701 in the POS server 700 executes information processing based on the transaction management program PRG (hereinafter, referred to as transaction search processing). FIG. 22 is a flowchart of the transaction search processing. In the case where the “accounting gate 400” is mentioned below in the description of the transaction search processing, it refers to the accounting gate 400 that has made the above inquiry.

In ACT731, the processor 701 searches, from the past transactions for which the payment has been completed, for the transaction including, as a transaction product, the product identified by the product code notified in the inquiry. For example, first, the processor 701 extracts transaction data that matches the following conditions from the transaction data included in the transaction database DBA.
It relates to a transaction carried out within a predetermined search period.
It includes, as a transaction product, the product identified by the notified product code.
It includes leaving data indicating that the customer CU has not left yet.

Note that the search period is assumed to be a certain time period such as the most recent 10 minutes. What period this search period is may be determined as appropriate by the specification maker of the product sales system 1, the store manager, or the like. For example, the search period may be the current day. Further, a predetermined number of recent transactions may be targets to be searched for. In this case, the period during which the corresponding number of transactions were made is the search period. The number of recent transactions is assumed to be 20 as an example. However, this number of transactions may be determined as appropriate by the specification maker of the product sales system 1, the store manager, or the like.

In ACT732, the processor 701 checks whether or not the corresponding transaction has been found by the above search. When the processor 701 was unable to extract transaction data that matches the conditions in ACT731, for example, the processor 701 then determines it as NO because the corresponding transaction has not been found, and the processing of the processor 701 proceeds to ACT733.

In ACT733, the processor 701 notifies the accounting gate 400 of an error as a response to the inquiry about a transaction. That is, when the processor 701 was unable to find a transaction that matches the above conditions, the processor 701 determines it as an error and notifies the accounting gate 400 of the error. The processor 701 then ends the transaction search processing.

When the processor 701 was able to extract even one piece of transaction data that matches the conditions in ACT731, for example, the processor 701 then determines it as YES in ACT732 because the corresponding transaction has been found, and the processing of the processor 701 proceeds to ACT734. In ACT734, the processor 701 checks whether or not a plurality of transactions has been found by the above search. When the processor 701 has extracted only one piece of transaction data that matches the conditions in ACT731, for example, the processor 701 then determines it as NO because a plurality of transactions has not been found, and the processing of the processor 701 proceeds to ACT735.

In ACT735, the processor 701 notifies the accounting gate 400 of allowance as a response to the inquiry of a transaction. That is, when the processor 701 was able to narrow down transaction to one transaction by the above conditions, the processor 701 determines it as allowance and notifies the accounting gate 400 of the allowance. By executing the information processing based on the transaction management program PRG by the processor 701 in this way, the computer that includes the processor 701 as the central part function as a second notification means. The processor 701 then ends the transaction search processing.

When a plurality of pieces of transaction data has been extracted in ACT731, for example, the processor 701 determines it as YES in ACT734 and the processing of the processor 701 proceeds to ACT736. In ACT736, the processor 701 checks whether or not the end condition for narrowing down has been met. The end condition may be determined as appropriate by the specification maker of the product sales system 1, the store manager, or the like. Note that a specific example of the end condition will be described below. When the corresponding event cannot be confirmed, the processor 701 then determines it as NO and the processing of the processor 701 proceeds to ACT737. In ACT737, the processor 701 requests the accounting gate 400 to make a notification of another product.

After making an inquiry about a transaction in ACT423 in FIG. 13, the processing of the processor 401 in the accounting gate 400 proceeds to ACT424. In ACT424, the processor 401 checks whether or not a request to make a notification of another product has been made. When the corresponding event cannot be confirmed, the processor 401 then determines it as NO and the processing of the processor 401 proceeds to ACT425. In ACT425, the processor 401 checks whether or not an allowance notification has been made. That is, the processor 401 determines whether to receive an allowance notification from the processor 701. When the corresponding event cannot be confirmed, the processor 401 then determines it as NO and the processing of the processor 401 proceeds to ACT426. In ACT426, the processor 401 checks whether or not an error notification has been made. When the corresponding event cannot be confirmed, the processor 401 then determines it as NO and the processing of the processor 401 returns to ACT424. In this way, in ACT424 to ACT426, the processor 401 stands by until either a notification request, an allowance notification, or an error notification is made. When a notification of another product is requested from the POS server 700 as described above, the processor 401 then determines it as YES in ACT424 and the processing of the processor 401 proceeds to ACT441 in FIG. 14.

In ACT441, the processor 401 displays an additional request screen on the touch panel 404. The additional request screen is a screen that requests the customer CU to cause the fixed scanner 406 or the handy scanner 407 to read the product barcode of a transaction product different from those that have been read so far.

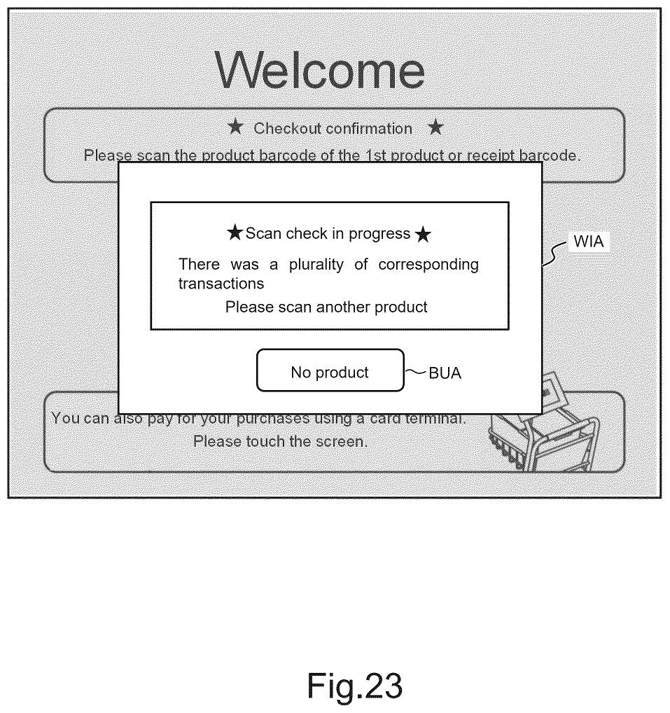

FIG. 23 is a diagram showing an example of the additional request screen. The additional request screen shown in FIG. 23 is a screen that displays a window WIA superimposed on the stand-by screen. The window WIA shows a text message for the above request and a button BUA. The button BUA is a soft key for the customer CU to declare that there is no other product.

When there is another transaction product whose product code has not been read yet, the customer CU causes the fixed scanner 406 or the handy scanner 407 to read the product barcode of one of the corresponding transaction products. Further, when the product barcodes of all the transaction products have been already read, the customer CU declares “no product” by a predetermined operation such as tapping the button BUA.

The processor 401 displays an additional request screen in ACT441 in FIG. 14 and then, the processing of the processor 401 proceeds to ACT442. In ACT442, the processor 401 checks whether or not a product barcode has been scanned. When the corresponding event cannot be confirmed, the processor 401 then determines it as NO and the processing of the processor 401 proceeds to ACT443. In ACT443, the processor 401 checks whether or not “no product” has been declared. When the corresponding event cannot be confirmed, the processor 401 then determines it as NO and the processing of the processor 401 proceeds to ACT444. In ACT444, the processor 401 checks whether or not the customer CU has passed through the checkout lane LA. When the corresponding event cannot be confirmed, the processor 401 then determines it as NO and the processing of the processor 401 proceeds to ACT442. In this way, in ACT442 to ACT444, the processor 401 stands by until a product barcode is scanned, “no product” is declared, or the customer CU has passed.

When a product barcode has been read by the fixed scanner 406 or the handy scanner 407, the processor 401 determines it as YES in ACT442 and the processing of the processor 401 proceeds to ACT445. In ACT445, the processor 401 requests the POS server 700 to perform narrowing down with a notification of the product code included in the barcode information obtained by reading the above product barcode by the fixed scanner 406 or the handy scanner 407. In this way, by executing the information processing based on the gate control program PRD by the processor 401, the computer that includes the processor 401 as the central part functions as a first notification means. After that, the processing of the processor 401 returns to the stand-by state in ACT424 to ACT426 in FIG. 13.

Further, when an operation to declare “no product” has been detected by, for example, the touch panel 404, the processor 401 determines it as YES in ACT443 and the processing of the processor 401 proceeds to ACT446. In ACT446, the processor 401 notifies the POS server 700 of “no product”. After that, the processing of the processor 401 returns to the stand-by state in ACT424 to ACT426 in FIG. 13.

The processor 701 in the POS server 700 requests for a notification of another product in ACT737 in FIG. 22 and then, the processing of the processor 701 proceeds to ACT738. In ACT738, the processor 701 checks whether or not narrowing down has been requested. When the corresponding event cannot be confirmed, the processor 701 then determines it as NO and the processing of the processor 701 proceeds to ACT739.

In ACT739, the processor 701 checks whether or not a notification of “no product” has been made. When the corresponding event cannot be confirmed, the processor 701 then determines it as NO and the processing of the processor 701 proceeds to ACT740. In ACT740, the processor 701 checks whether or not a notification of false passage has been made. When the corresponding event cannot be confirmed, the processor 701 then determines it as NO and the processing of the processor 701 returns to ACT738.

In this way, in ACT738 to ACT740, the processor 701 stands by until a request for narrowing down, a notification of “no product”, or a notification of false passage is made. The narrowing down has been requested as described above, the processor 701 then determines it as YES in ACT738 and the processing of the processor 701 proceeds to ACT741.

In ACT741, the processor 701 narrows down the plurality of transactions that has been searched for in ACT731 to a transaction that includes, as transaction products, both the product identified by the product code notified in the inquiry and the product identified by the product code notified in the request for narrowing down. After that, the processor 701 repeats the processing of ACT734 and subsequent ACTs in the same manner as that described above. In this way, when transactions cannot be narrowed down to one transaction in ACT741, the processor 701 repeats the narrowing down in ACT741 while receiving a request for narrowing down with a notification of still another product code. Note that when executing the processing of ACT741 for the second and subsequent times, the processor 701 narrows down transactions to a transaction that includes, as transaction products, all the product identified by the product code notified in the inquiry and the plurality of products identified by the product codes notified in the plurality of requests for narrowing down. In this way, the processor 701 narrows down the transactions by the processing of ACT731 to ACT741. In this way, by executing the information processing based on the transaction management program PRG by the processor 701, the computer that includes the processor 701 as the central part functions as a narrowing down means.

Incidentally, the end condition checked by the processor 701 in ACT736 is assumed to be determined as, for example, a case where the number of products used to narrow down transactions has reached a predetermined number. When the transactions cannot be narrowed down to one transaction even if the end condition is met, the processor 701 then determines it as YES in ACT736 and the processing of the processor 701 proceeds to ACT742. That is, when there is a plurality of transactions that includes a predetermined number of products as transaction products similarly, the processing of the processor 701 proceeds to ACT742.

In ACT742, the processor 701 notifies the accounting gate 400 of an error as a response to the inquiry of a transaction. That is, when the transactions cannot be narrowed down to one transaction even if the end condition is met, the processor 701 determines it as an error and notifies the accounting gate 400 of the error. The processor 701 then ends the transaction search processing.

When a notification of “no product” has been made as described above, the processor 701 determines it as YES in ACT739 and the processing of the processor 701 proceeds to ACT743. In ACT743, the processor 701 narrows down the plurality of transactions that has been narrowed down so fat to a transaction whose number of traded products matches the number of transaction products used for narrowing down so far. Note that the number of traded products is shown in, for example, the transaction header included in the transaction data.

In ACT744, the processor 701 checks whether or not a plurality of transactions has been found by the above narrowing down. When the transactions have been narrowed down to one transaction, the processor 701 then determines it as NO because a plurality of transactions has not been found, and the processing of the processor 701 proceeds to ACT745. In ACT745, the processor 701 notifies the accounting gate 400 of allowance as a response to the inquiry of a transaction. That is, when the transactions can be narrowed down to one transaction by the narrowing down in ACT743, the processor 701 determines it as allowance and notifies the accounting gate 400 of the allowance. The processor 701 then ends the transaction search processing.

When a plurality of transactions has been found by the above narrowing down, the processor 701 determines it as YES in ACT744 and the processing of the processor 701 proceeds to ACT746. In ACT746, the processor 701 notifies the accounting gate 400 of an error as a response to the inquiry of a transaction. That is, in the case where another transaction regarding the same transaction product as the transaction product in the transaction that is the target of this inquiry has been made in the search period, the processor 701 determines it as an error and notifies the accounting gate 400 of the error. The processor 701 then ends the transaction search processing.

Upon receiving the allowance notification made by the processor 701 in the POS server 700 in ACT735 or ACT745 as described above, the processor 401 of the accounting gate 400 determines it as YES in ACT425 in FIG. 13 and the processing of the processor 401 proceeds to ACT427. In ACT427, the processor 401 executes the pass-through allowance processing similarly to ACT413 in FIG. 12. When the pass-through allowance processing is completed, the processing of the processor 401 then returns to ACT401 in FIG. 12. In this way, in the case where the processor 401 determines it as YES in ACT425 in accordance with the reception of the allowance notification made by the processor 701 in ACT735 and the processing of the processor 401 proceeds to ACT427, the processor 401 is performing control for allowing the customer CU to pass through the checkout lane LA in accordance with the fact that the transactions has been narrowed down to one transaction. In this way, by executing the information processing based on the gate control program PRD by the processor 401, the computer that includes the processor 401 as the central part functions as a control means.

Upon receiving the error notification made by the processor 701 in the POS server 700 in ACT733, ACT742, or ACT746 in FIG. 22 as described above, the processor 401 determines it as YES in ACT426 in FIG. 13 and the processing of the processor 401 proceeds to ACT428. In ACT428, the processor 401 executes call processing. The call processing is processing for calling a staff member responsible for dealing with the error in the accounting gate 400 (hereinafter, referred to as a responsible person) and causing the responsible person to deal with the error. In the case where the processing of the processor 401 proceeds to ACT428 in accordance with the reception of the error notification made by the processor 701 in this way, the processor 401 is performing processing for causing the responsible person to deal with in accordance with the fact that the transaction could not be narrowed down to one transaction. In this way, by executing the information processing based on the gate control program PRD by the processor 401, the computer that includes the processor 401 as the central part functions as a processing means.

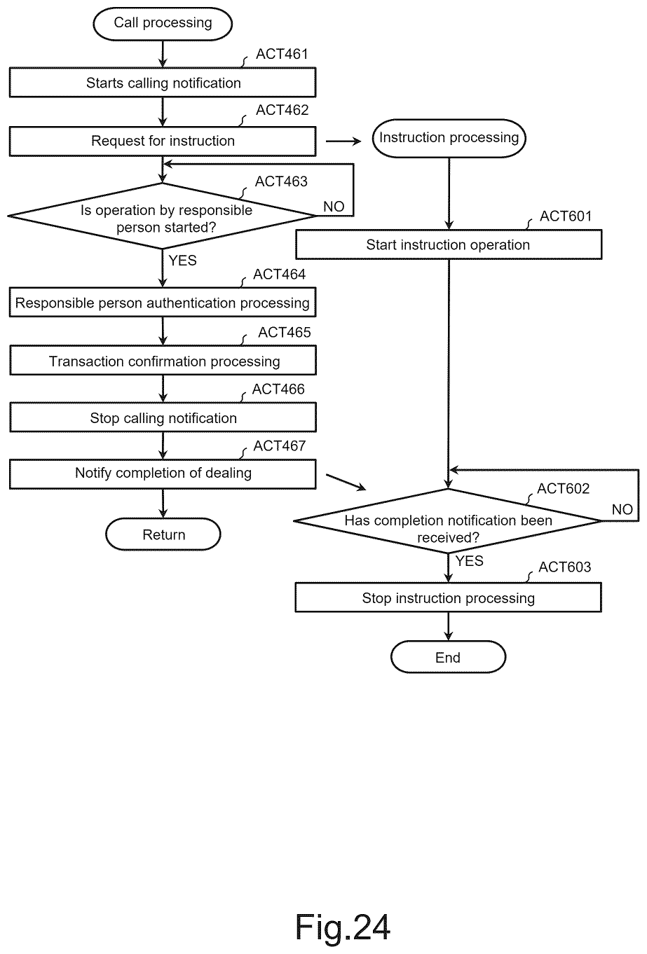

FIG. 24 is a flowchart of call processing by the processor 401 in the accounting gate 400 and instruction processing by the processor 601 in the monitoring terminal 600. In ACT461, the processor 401 starts a calling notification. The calling notification is a notification that a sales clerk is being called to the customer CU. For the calling notification, for example, the processor 401 displays a calling screen on the touch panel 404. For the calling notification, for example, the processor 401 displays a warning screen on the display device 405. For the calling notification, for example, the processor 401 causes the lamp device 410 to be lit yellow or blink yellow. For the calling notification, for example, the processor 401 causes the sound device 411 to output a predetermined notification sound. Alternatively, for the calling notification, for example, the processor 401 may cause the sound device 411 to perform another operation such as outputting a predetermined voice message. However, for the pass-through allowance notification, the processor 401 may execute only some of these for the calling notification.

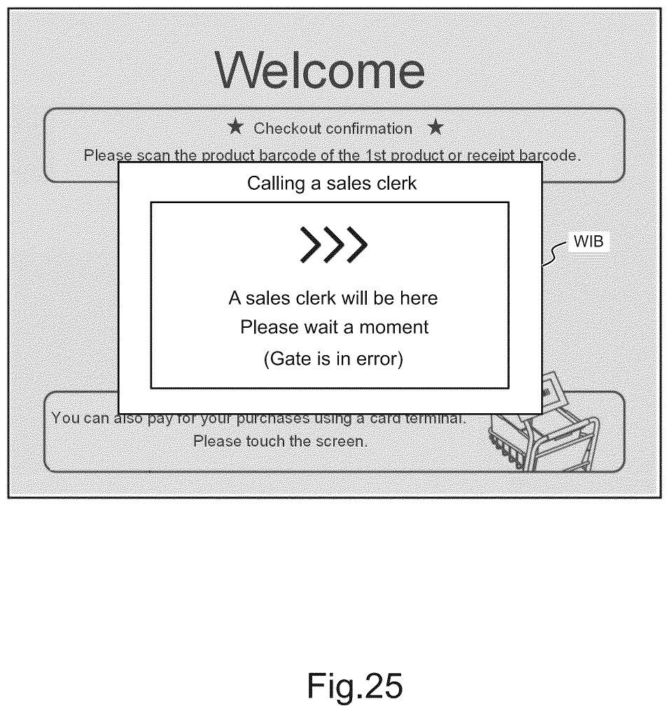

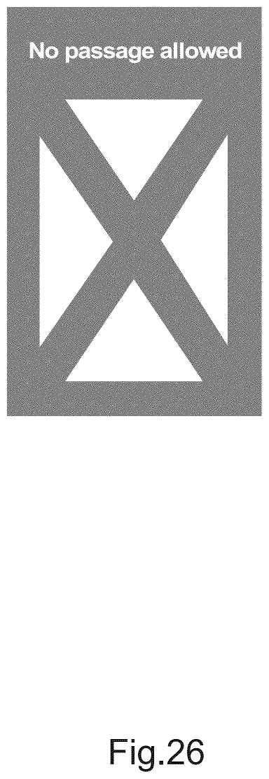

FIG. 25 is a diagram showing an example of the calling screen. The calling screen shown in FIG. 25 is a screen that displays a window WIB superimposed on the stand-by screen. The window WIB shows a text message for the above guidance. FIG. 26 is a diagram showing an example of the warning screen. The warning screen shown in FIG. 26 is a screen for warning the customer CU in order to prevent him/her from accidentally leaving.

In ACT462 in FIG. 24, the processor 401 requests a predetermined request destination for instruction. In this embodiment, assumption is made that the monitoring terminal 600 is set as a request destination for instruction. The monitoring terminal 600 is installed at, for example, the service counter of the store. The monitoring terminal 600 performs an operation for transaction processing by the same operation as that of the existing POS terminal of the same type. This allows the monitoring terminal 600 to be used to provide assistance when the POS terminal 200 is busy. Further, the monitoring terminal 600 can be used to deal with various requests from the customer CU, such as returns.

Incidentally, upon receiving a request for instruction made from the accounting gate 400 as described above, the processor 601 in the monitoring terminal 600 executes the instruction processing shown in FIG. 24 in accordance with the monitoring program PRF. In ACT601, the processor 601 starts an instruction operation. The instruction operation is an operation for instructing the responsible person responsible for monitoring using the monitoring terminal 600 to deal with the error in the accounting gate 400. As an instruction operation, for example, the processor 601 displays an instruction screen for instructing to deal with the error in the corresponding accounting gate 400 on the sales-clerk-side touch panel 604 such that which accounting gate 400 has requested the instruction can be recognized. As the instruction operation, for example, the processor 601 causes the sound device 613 to output a predetermined instruction sound. Alternatively, as the instruction operation, for example, the processor 601 may cause the sound device 613 to perform another operation such as outputting a predetermined voice message. However, the processor 601 may execute only some of these as the instruction operation.

The processor 401 in the accounting gate 400 makes a request for instruction in ACT462 and then, the processing of the processor 401 proceeds to ACT463. In ACT463, the processor 401 stands by until an operation by the responsible person is started.

The responsible person goes to the accounting gate 400 in accordance with the instruction operation in the monitoring terminal 600 and performs a predetermined operation that he/she should perform. When such an operation has been performed, the processor 401 determines it as YES in ACT463 and the processing of the processor 401 proceeds to ACT464. In ACT464, the processor 401 performs authentication processing for confirming that the operator is the responsible person. This authentication may be known processing for operator authentication. When the authentication has succeeded, the processing of the processor 401 then proceeds to ACT465.

In ACT465, the processor 401 performs transaction confirmation processing for causing the responsible person to confirm that the customer CU who is currently using the accounting gate 400 has completed the payment for the transaction. In this transaction confirmation processing, for example, the processor 401 displays a transaction confirmation screen indicating the content of the paid transaction on the touch panel 404. The processor 401 then receives, for example, an instruction regarding which of the paid transactions this transaction of the corresponding customer CU is from the responsible person.

In ACT466, the processor 401 stops the calling notification. In ACT467, the processor 401 notifies the monitoring terminal 600 of the completion of dealing. The processor 401 then ends this call processing, the processing of the processor 401 proceeds to ACT427 in FIG. 13, and the pass-through allowance processing is executed in the same manner as that described above.

The processor 601 in the monitoring terminal 600 starts an instruction operation in ACT601 and then, the processing of the monitoring terminal 600 proceeds to ACT602. In ACT602, the processor 601 stands by until a completion notification is received. When the notification of completion has been made from the accounting gate 400 as described above, the processor 601 then determines it as YES in ACT602 and the processing of the processor 601 proceeds to ACT603. In ACT603, the processor 601 stops the instruction operation. The processor 601 then ends this instruction processing.

When the barcode read while the stand-by screen is displayed is a receipt barcode, the processor 401 in the accounting gate 400 determines it as YES in ACT422 in FIG. 13 and the processing of the processor 401 proceeds to ACT429. In ACT429, the processor 401 checks whether or not the read receipt barcode is valid for checking leaving using the accounting gate 400. The processor 401 checks whether or not the receipt barcode matches a predetermined condition and determines, in the case where it matches the predetermined condition, it as valid. The above condition is assumed to be, for example, a case where the corresponding receipt barcode is a receipt barcode relating to the transaction processed by a device that is installed in the same store as that where the accounting gate 400 is installed and is not a POS terminal included in the rejection list data DAB. However, the condition may be determined as appropriate by the specification maker of the product sales system 1, the store manager, or the like. For example, only one of the above two conditions may be used. Alternatively, another condition such as the time that has elapsed since the completion of the transaction relating to the receipt barcode being less than a predetermined time may be added. When it can be determined that the read receipt barcode is valid, the processor 401 determines it as YES in ACT429 and the processing of the processor 401 proceeds to ACT430. In this embodiment, in the case where the receipt barcode relating to the transaction for which processing for payment was performed by the POS terminal 300, the accounting gate 400, or the monitoring terminal 600 is read, the processing of the processor 401 proceeds to ACT430.

In ACT430, the processor 401 makes an inquiry to the POS server 700 about the leaving status of the customer CU with a notification of the transaction code included in the barcode information indicated by the read receipt barcode. Upon receiving the above inquiry about the leaving status, the processor 701 in the POS server 700 executes information processing based on the transaction management program PRG (hereinafter, referred to as leaving checking processing).

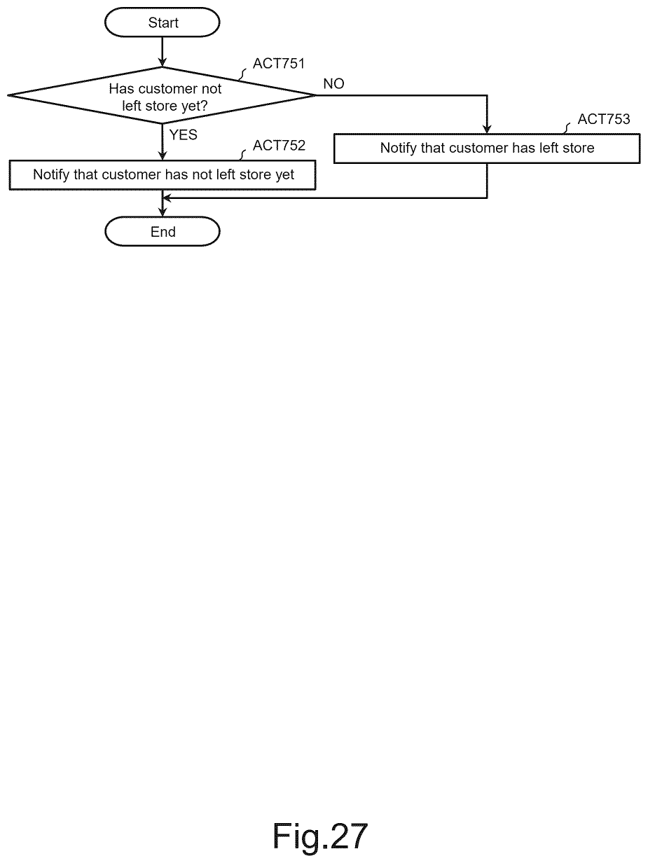

FIG. 27 is a flowchart of the leaving checking processing. In ACT751, the processor 701 checks whether or not the customer CU relating to the transaction identified by the notified transaction code has not left the store yet. For example, the processor 701 searches the transaction database DBA for the transaction data relating to the transaction identified by the notified transaction code and checks whether or not the leaving data included in the corresponding transaction data indicates the state representing that the customer CU has not left yet. When the corresponding leaving data indicates the state representing that the customer CU has not left yet, the processor 701 determines it as YES in ACT751 because the customer CU has not left the store yet, and the processing of the processor 701 proceeds to ACT752. In ACT752, the processor 701 notifies the accounting gate 400 that is the source of the inquiry of that the customer CU has not left yet as a response to the inquiry about the leaving status.

Further, when the corresponding leaving data does not indicate the state representing that the customer CU has not left yet, the processor 701 determines it as NO in ACT751 because the customer CU has left the store, and the processing of the processor 701 proceeds to ACT753. In ACT753, the processor 701 notifies the accounting gate 400 that is the source of the inquiry of that the customer CU has left the store as a response to the inquiry about the leaving status. When the notification in ACT752 or ACT753 is finished, the processor 701 then ends this leaving checking processing.

The processor 401 in the accounting gate 400 makes an inquiry in ACT430 in FIG. 13, and then, the processing of the processor 401 proceeds to ACT431. In ACT431, the processor 401 checks whether or not it has been notified of that the customer CU has not left yet. When it has been notified of that the customer CU has not left yet from the POS server 700 as described above, the processor 401 determines it as YES in ACT431, the processing of the processor 401 proceeds to ACT427, and the pass-through allowance processing is executed in the same manner as that described above. At this time, when requesting to update the leaving data in ACT454 in FIG. 17, the processor 401 makes a notification of the transaction code included in the barcode information indicated by the read receipt barcode. Upon receiving such a request, the processing of the processor 701 of the POS server 700 proceeds to, for example, ACT722 in FIG. 21. In ACT722, the processor 701 searches the transaction database DBA for the transaction data identified by the notified transaction code and updates the leaving data included in the corresponding transaction data to the state representing that the customer CU has left the store.

When it is not confirmed that the read receipt barcode is valid for checking leaving using the accounting gate 400, the processor 401 determines it as NO in ACT429 in FIG. 13 because the read receipt barcode is invalid, the processing of the processor 401 proceeds to ACT428, and the call processing is executed in the same manner as that described above. In this way, for example, in the case where the receipt barcode relating to the transaction processed by the POS terminal 300 has been read, a sales clerk is called without allowing the customer CU to pass through.

Further, when it is notified of that the customer CU has left the store from the POS server 700 as described above, the processor 401 determines it as NO in ACT431, the processing of the processor 401 proceeds to ACT428, and the call processing is executed in the same manner as that described above. In this way, in the case where the receipt barcode relating to the transaction for which it has been confirmed that the customer CU has left the store has been read, a sales clerk is called without allowing the customer CU to pass through.

Incidentally, when the customer CU has passed through the checkout lane LA in the stand-by state in ACT402 to ACT404 in FIG. 12 and this is detected by the motion detector 409, the processor 401 determines it as YES in ACT404 because the customer CU has passed through, and the processing of the processor 401 proceeds to ACT414. In ACT414, the processor 401 executes false pass processing.

Meanwhile, when the customer CU has passed through the checkout lane LA in the stand-by state in ACT442 to ACT444 in FIG. 14 and this is detected by the motion detector 409, the processor 401 determines it as YES in ACT444 because the customer CU has passed through, and the processing of the processor 401 proceeds to ACT447. In ACT447, the processor 401 notifies the POS server 700 of false passage. In ACT448, the processor 401 executes false pass processing.

When the processor 401 is in the stand-by state in ACT442 to ACT444 in FIG. 14, the processor 701 in the POS server 700 is in the stand-by state in ACT738 to ACT740 in FIG. 22. For this reason, upon receiving the above notification of false passage, the processor 701 determines it as YES in ACT740 and ends the transaction search processing.

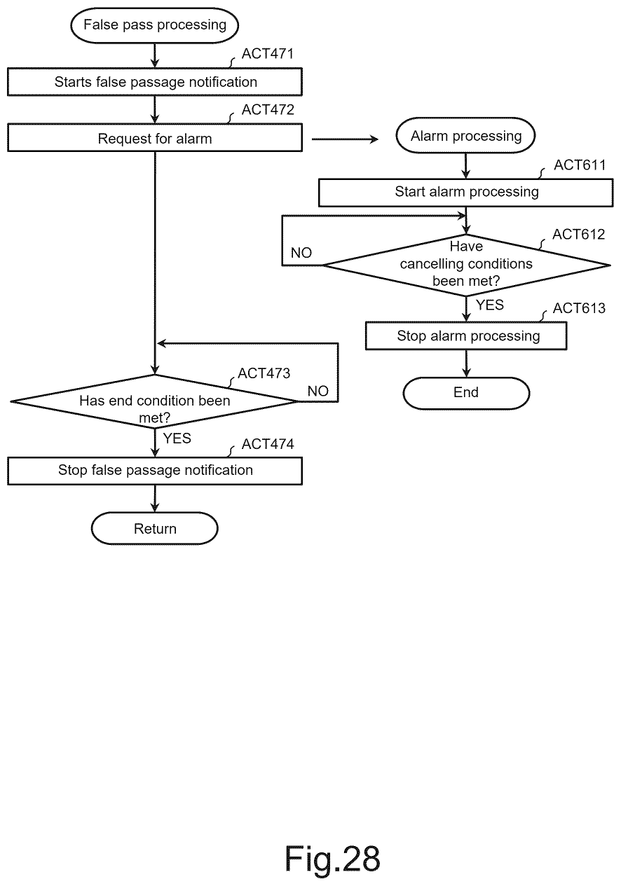

FIG. 28 is a flowchart of false pass processing by the processor 401 in the accounting gate 400 and alarm processing by the processor 601 in the monitoring terminal 600. Note that the false pass processing is executed in the procedure shown in FIG. 28 in both cases where it is executed in ACT414 in FIG. 12 and it is executed in ACT448 in FIG. 14.

In ACT471, the processor 401 starts a false passage notification. The false passage notification is a notification indicating that the customer CU has passed through the checkout lane LA that does not allow him/her to pass therethrough, to the customer CU and other persons around him/her. For the false passage notification, for example, the processor 401 displays a first warning screen on the touch panel 404. For the false passage notification, for example, the processor 401 displays a second warning screen on the display device 405. For the false passage notification, for example, the processor 401 causes the lamp device 410 to be lit red or blink red. For the false passage notification, for example, the processor 401 causes the sound device 411 to output a predetermined alarm sound.

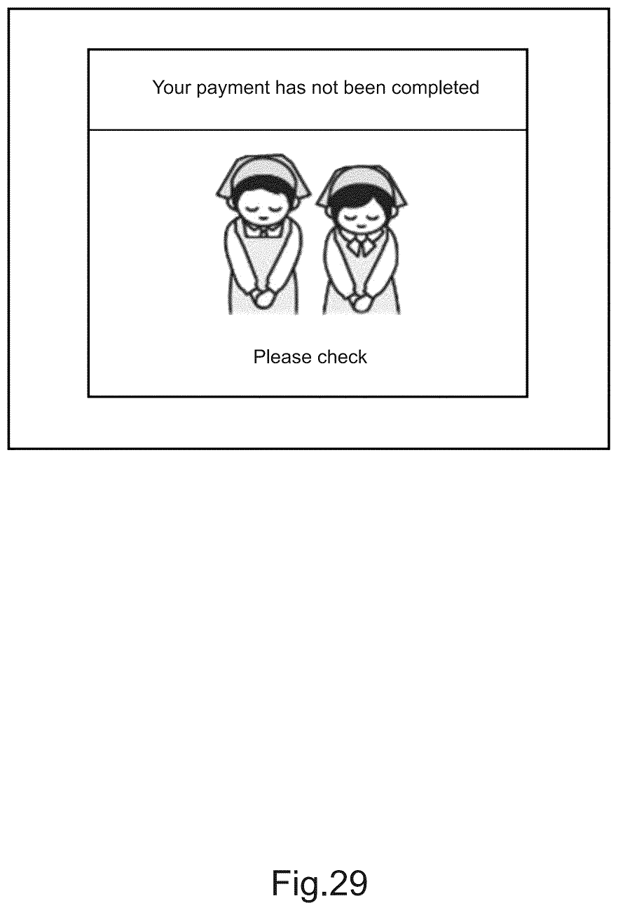

Alternatively, for the false passage notification, for example, the processor 401 may cause the sound device 411 to perform another operation such as outputting a predetermined voice message. However, the processor 401 may execute only some of these for the false passage notification. FIG. 29 is a diagram showing an example of the first warning screen. The second warning screen is, for example, a screen similar to the warning screen shown in FIG. 26.

In ACT472 in FIG. 28, the processor 401 requests a predetermined request destination for an alarm. In this embodiment, assumption is made that the monitoring terminal 600 is determined as a request destination of an alarm. Incidentally, upon receiving a request for an alarm made from the accounting gate 400 as described above, the processor 601 in the monitoring terminal 600 executes the alarm processing shown in FIG. 28 in accordance with the monitoring program PRF.

In ACT611, the processor 601 starts alarm processing. The alarm processing is processing for issuing an alarm regarding illegal passage of the checkout lane LA to the sales clerk CL who is responsible for monitoring using the monitoring terminal 600. For the alarm processing, for example, the processor 601 displays, on the sales-clerk-side touch panel 604, an alarm screen for causing the sales clerk CL to recognize that there has been illegal passage. For the alarm processing, for example, the processor 601 causes the sound device 613 to output a predetermined alarm sound. Alternatively, for the alarm processing, for example, the processor 601 may cause the sound device 613 to operate another operation such as outputting a predetermined voice message. However, the processor 601 may execute only some of these for the alarm processing.

In ACT612, the processor 601 stands by until the condition for cancelling the alarm are met. The cancelling condition may be determined as appropriate by, for example, the specification maker of the product sales system 1 or the administrator of the monitoring terminal 600. The canceling condition is assumed to be, for example, a case where cancellation is instructed by a predetermined operation on the sales-clerk-side touch panel 604 or the keyboard 605. Alternatively, the canceling condition is assumed to be a case where the duration of the alarm processing has exceeded a predetermined time. When the canceling condition has been met, the processor 601 then determines it as YES in ACT612 and the processing of the processor 601 proceeds to ACT613. In ACT613, the processor 601 stops the alarm processing. The processor 601 then ends this alarm processing.

Incidentally, the processor 401 in the accounting gate 400 requests for an alarm in ACT472 and then, the processing of the processor 401 proceeds to ACT473. In ACT473, the processor 401 stands by until the end condition for the false passage notification is met. The end condition may be determined as appropriate by, for example, the specification maker of the product sales system 1 or the administrator of the accounting gate 400. The end condition is assumed to be, for example, a case where the duration of the false passage notification has exceeded a predetermined time. Alternatively, the end condition is assumed to be a case where an instruction to cancel the alarm processing has been made in the monitoring terminal 600. In this case, the processor 601 in the monitoring terminal 600 notifies the accounting gate 400 of that it determines, in the case where the cancelling instruction has been made, it as YES in ACT612 because the canceling condition is met and that the cancelling instruction has been made before or after ACT613. Alternatively, the end condition is assumed to be a case where a predetermined cancelling operation by a sales clerk is performed in the accounting gate 400. When the end condition is met, the processor 401 then determines it as YES in ACT473 and the processing of the processor 401 proceeds to ACT474. In ACT474, the processor 401 stops the false passage notification. The processor 401 then ends this false pass processing and the processing of the processor 401 returns to ACT401 in FIG. 12.

As described above, in the product sales system 1, the product barcode of one or more transaction products for which a payment has been made is read again in the accounting gate 400, and the customer CU is allowed to leave the store when the paid transactions including such a transaction product can be narrowed down to one transaction. In this way, it is possible to guide the customer CU who has paid for the transaction but cannot cause the accounting gate 400 to read the receipt barcode to leave the store.

Further, in the product sales system 1, the transactions to be narrowed down are limited to those for which a payment has been completed within the most recent predetermined period. This increases the probability of narrowing down the transactions to one transaction without the necessity for the customer CU to cause product barcodes of many products to be read, and reduces the burden on the customer CU. Further, it is possible to reduce the load on the processor 701 relating to the narrowing down processing.

Further, in the product sales system 1, regarding the transaction for which it has been confirmed that the customer CU has left, the fact that the customer CU has left can be confirmed using the leaving data and the corresponding transaction is excluded from the target of narrowing down. This increases the probability of narrowing down the transactions to one transaction without the necessity for the customer CU to cause product barcodes of many products to be read, and reduces the burden on the customer CU. Further, it is possible to reduce the load on the processor 701 relating to the narrowing down processing.

Further, in the product sales system 1, when the transactions cannot be narrowed down to one transaction by checking a predetermined number of transaction products, a responsible person is called without reading any more products. This reduces the burden on the customer CU as he/she does not need to repeat the operation of causing product barcodes of many products to be read, even if the number of transaction products is large and the transactions cannot be narrowed down to one transaction by checking a small number of products.

In this embodiment, various modifications can be made as follows. The transactions to be narrowed down do not necessarily need to be excluded by the period in which the payment has been made, the leaving status of the customer CU, or the like.

The leaving status of the customer CU for each transaction does not necessarily need to be managed.

After acquiring a plurality of product codes, transactions including the plurality of transaction products as transaction products may be narrowed down by referring to the transaction database DBA.

After acquiring product codes of all transaction products, transactions in which all transaction products match the transaction products may be narrowed down by referring to the transaction database DBA.

The original transaction database DBA or the copy thereof may be stored in the auxiliary storage device 403 of the accounting gate 400. That is, in this case, the storage means is provided in the accounting gate 400 as a gate device. Further, the transaction database DBA may be stored in a storage device provided in an arbitrary information processing apparatus different from the accounting gate 400 and the POS server 700. Further, the transaction database DBA may be stored in an independent storage device externally attached to various information processing apparatuses.

The information processing for narrowing down transactions may be performed by the processor 401 in the accounting gate 400. Alternatively, the information processing may be performed by an arbitrary information processing apparatus different from the accounting gate 400 and the POS server 700.

The information processing as a control means may be performed by an arbitrary information processing apparatus different from the accounting gate 400, such as the POS server 700.

The accounting gate 400 may include a device that has a function as an accounting machine and a device that has a function as a gate, which are separate from each other.

A mechanism that is capable of selectively forming a state in which the checkout lane LA is physically blocked and a state in which the checkout lane LA is not blocked may be provided, and the opening/closing operation of the mechanism may be executed as one notification.

Transaction products may be registered in the POS terminal 300 and a payment is made in the accounting gate 400.

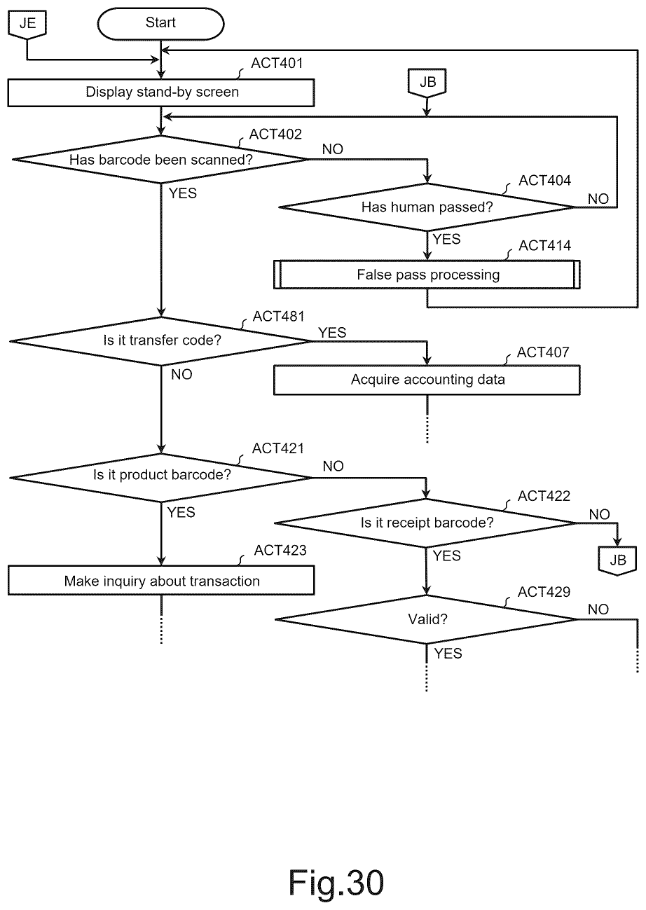

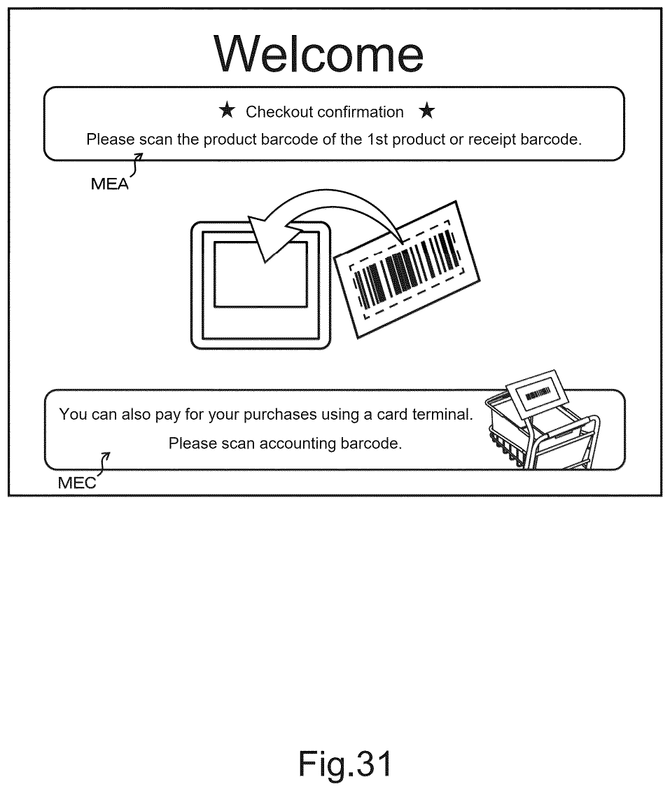

The touch operation on the stand-by screen before the customer CU causes the transfer code to be read may be omitted. FIG. 30 is a diagram showing a modification of the gate control processing. Note that FIG. 30 shows only the changes in the gate control processing from FIG. 12 and FIG. 13 and the same processing is denoted by the same reference symbols. The processor 401 displays a stand-by screen in ACT401 and then enters the stand-by state in ACT402 and ACT404 in FIG. 30 instead of the stand-by state in ACT402 to ACT404 in FIG. 12. That is, the processor 401 stands by in this stand-by state until a barcode is scanned or a human passes but not until a screen is tapped. The customer CU causes the reading port of the handy scanner 407 to face the transfer code without touching the screen of the touch panel 504. Alternatively, the customer CU causes the fixed scanner 406 or the handy scanner 407 to read the receipt barcode or the product barcode. When it is notified of the barcode information from the fixed scanner 406 or the handy scanner 407, the processing of the processor 401 proceeds to ACT481. In ACT481, the processor 401 checks whether or not the read barcode is a transfer code. When it has been confirmed that the read barcode is a transfer code, the processor 401 then determines it as YES in ACT481 and the processing of ACT407 and subsequent ACTs is executed in the same manner as that described above. When it has not been confirmed that the read barcode is a transfer code, the processor 401 determines it as NO in ACT481 and the processing of the processor 401 proceeds to ACT421. The processor 401 then executes the processing of ACT421 and subsequent ACTs in the same manner as that described above. Note that when implementing such a modification, it is also favorable to change the stand-by screen. FIG. 31 is a diagram showing an example of a stand-by screen adapted to this modification. The stand-by screen shown in FIG. 31 includes the text message MEA and a text message MEC. That is, the stand-by screen shown in FIG. 31 shows the text message MEC instead of the text message MEB in the stand-by screen shown in FIG. 15. The text message MEC guides the customer CU to cause the transfer barcode to be read in order to start a payment for the transaction product registered using the information processing terminal 500. Note that in the stand-by screen shown in FIG. 31, the illustration in the center is also replaced with one that gives the customer CU an idea of an operation of causing the barcode to be read.

Some or all of the respective functions realized by each processor by information processing can also be realized by hardware that executes information processing that is not based on a program, such as a logic circuit. Further, the respective functions described above can also be realized by combining hardware such as the above logic circuit with software control.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A checkout system, comprising:
a storage device that stores list data indicating a list of transaction products that are subjects of a transaction in a store for each paid transaction;
a scanner that acquires an identifier of a product in accordance with an operation of a customer;
a notification device that notifies the customer of that he/she is allowed to pass through;
a first processor configured to narrow down transactions including one or more products identified by one or more identifiers acquired by the scanner as transaction products by referring to the list data stored in the storage device; and
a second processor configured to control the notification device to notify the customer of that he/she is allowed to pass through in accordance with narrowing down of the transactions to one transaction by the first processor.

2. The checkout system according to claim 1, wherein
the first processor is further configured to narrow down transactions for which a payment has been completed within a most recent predetermined period.

3. The checkout system according to claim 1, wherein
the first processor is further configured to exclude, where the narrowing down has narrowed down the transactions including one or more products identified by one or more identifiers as transaction products to one transaction, the corresponding transaction from a target of narrowing down.

4. The checkout system according to claim 1, wherein
the first processor is further configured to perform, where the transactions including one or more products identified by one or more identifiers as transaction products cannot be narrowed down to one transaction before a predetermined end condition is met, processing for causing a staff member to deal with.

5. The checkout system according to claim 1, wherein
the storage device further stores leaving data that indicates a leaving status of the customer from the store for each paid transaction, and
the first processor is further configured to exclude a transaction including leaving data that indicates a state representing that the customer has left from a target of narrowing down.

6. The checkout system according to claim 1, further comprising
an information processing apparatus that manages transactions,
the information processing apparatus including the storage device and the first processor.

7. The checkout system according to claim 1, further comprising
a gate device that is provided to face a checkout lane through which the customer passes when leaving the store,
the gate device including a scanner and a notification device.

8. The checkout system according to claim 7, wherein
the gate device further includes the second processor.

9. A control method for a checkout system, comprising:
storing, in a storage device, list data indicating a list of transaction products that are subjects of a transaction in a store for each paid transaction;
narrowing down transactions including one or more products identified by one or more identifiers acquired by a scanner in accordance with an operation of a customer as transaction products by referring to the list data stored in the storage device; and
controlling a notification device to notify the customer of that he/she is allowed to pass through in accordance with narrowing down of the transactions including one or more products identified by one or more identifiers as transaction products to one transaction by the narrowing down.

10. A checkout system, comprising:
a gate device that is provided to face a checkout lane through which a customer passes when leaving a store; and
an information processing apparatus that manages transactions in the store, wherein
the information processing apparatus includes
a storage device that stores list data indicating a list of transaction products that are subjects of a transaction in the store for each paid transaction, and
a first processor configured to
narrow down transactions including one or more products identified by one or more identifiers notified from the gate device as transaction products by referring to the list data stored in the storage device, and
notify, where the narrowing down has narrowed down the transactions including one or more products identified by one or more identifiers as transaction products to one transaction, the gate device of this fact, and wherein
the gate device includes
a scanner that acquires an identifier of a product in accordance with an operation of the customer,
a notification device that notifies the customer of that he/she is allowed to pass through, and
a second processor configured to
notify the information processing apparatus of the identifier of the product acquired by the scanner, and
control the notification device to notify the customer of that he/she is allowed to pass through in accordance with a notification of that the narrowing down has narrowed down the transactions to one transaction from the information processing apparatus.
